(19) United States
(12) Patent Application Publication
(10) Pub. No.: US 2024/0211574 A1
(43) Pub. Date: Jun. 27, 2024

(54) LEARNING MODEL CREATING SYSTEM, LEARNING MODEL CREATING METHOD, AND PROGRAM

(71) Applicant: RAKUTEN GROUP, INC., Tokyo (JP)

(72) Inventors: Kyosuke TOMODA, Setagaya-ku, Tokyo (JP); Shuhei ITO, Minato-ku, Tokyo (JP)

(21) Appl. No.: 17/909,746

(22) PCT Filed: Jun. 30, 2021
(86) PCT No.: PCT/JP2021/024840

§ 371 Date: Sep. 6, 2022

(51) Int. Cl. G06F 21/34; G06F 21/56; G06N 20/00

(52) U.S. Cl. CPC G06F 21/34; G06F 21/566; G06N 20/00; G06F 2221/034

(57) ABSTRACT

At least one processor of a learning model creating system acquires authenticated information relating to an action of an authenticated user who has executed a predetermined authentication from a user terminal from which a predetermined service is usable. At least one processor creates, based on the authenticated information, a learning model for detecting fraud in the service such that the action of the authenticated user is estimated to be valid.

### TECHNICAL FIELD

The present disclosure relates to a learning model creating system, a learning model creating method, and a program.

### BACKGROUND ART

Hitherto, there has been known a technology for detecting fraud by a user who is using a predetermined service. For example, in Patent Literature 1, there is described a system for creating a learning model. In the system, a learning model for detecting fraud in a service is created by training a learning model that uses supervised learning with training data in which a feature amount relating to an action of the user is an input and whether or not the action is fraudulent is an output.

### CITATION LIST

### Patent Literature

[PTL 1] WO 2019/049210 A1

### SUMMARY OF INVENTION

### Technical Problem

However, in the technology as described in Patent Literature 1, it is required to manually prepare the training data, and therefore it takes time and effort to create the learning model. This point is not limited to learning models using supervised learning. Even when a learning model using unsupervised learning or semi-supervised learning is to be created, it takes a lot of time and effort to manually collect information to be input to the learning model. For this reason, it is required to simplify the creation of the learning model.

An object of the present disclosure is to simplify creation of a learning model for detecting fraud in a service.

### Solution to Problem

According to one aspect of the present disclosure, there is provided a learning model creating system including: authenticated information acquisition means for acquiring authenticated information relating to an action of an authenticated user has who executed a predetermined authentication from a user terminal from which a predetermined service is usable; and creating means for creating, based on the authenticated information, a learning model for detecting fraud in the predetermined service such that the action of the authenticated user is estimated to be valid.

### Advantageous Effects of Invention

According to the present disclosure, the creation of the learning model for detecting the fraud in the service can be simplified.

### BRIEF DESCRIPTION OF DRAWINGS

FIG. 1 is a diagram for illustrating an example of an overall configuration of a fraud detection system.

FIG. 2 is a view for illustrating an example of a flow of use registration.

FIG. 3 is a view for illustrating an example of a flow of possession authentication.

FIG. 4 is a view for illustrating an example of how an NFC unit reads an IC chip of a card.

FIG. 5 is a diagram for illustrating an example of a learning model.

FIG. 6 is a functional block diagram for illustrating an example of functions implemented by a fraud detection system according to a first embodiment of the present disclosure.

FIG. 7 is a table for showing a data storage example of a user database.

FIG. 8 is a table for showing a data storage example of a training database.

FIG. 9 is a flow chart for illustrating an example of processing to be executed in the first embodiment.

FIG. 10 is a diagram for illustrating an outline of a second embodiment of the present disclosure.

FIG. 11 is a functional block diagram for illustrating an example of functions implemented by a fraud detection system according to the second embodiment.

FIG. 12 is a flow chart for illustrating an example of processing to be executed in the second embodiment.

FIG. 13 is a diagram for illustrating an example of an overall configuration of a fraud detection system according to Modification Example 1-1.

FIG. 14 is a view for illustrating an example of screens displayed on a user terminal in Modification Example 1-1.

FIG. 15 is a view for illustrating an example of a flow for increasing an upper limit amount after registration of a card.

FIG. 16 is a view for illustrating an example of how the NFC unit reads the IC chip of the card.

FIG. 17 is a functional block diagram in modification examples of the first embodiment.

FIG. 18 is a table for showing a data storage example of a user database.

FIG. 19 is a functional block diagram in modification examples of the second embodiment.

### DESCRIPTION OF EMBODIMENTS

### 1. First Embodiment

Now, a first embodiment of the present disclosure is described as an example of an embodiment of a learning model creating system according to the present disclosure. In the first embodiment, a case in which the learning model creating system is applied to a fraud detection system is taken as an example. Accordingly, the fraud detection system as used in the first embodiment can be read as “learning model creating system.” The learning model creating system may perform up to the creation of the learning model, and the fraud detection itself may be executed by another system. That is, the learning model creating system is not required to include the function of fraud detection among functions of the fraud detection system.

### [1-1. Overall Configuration of Fraud Detection System]

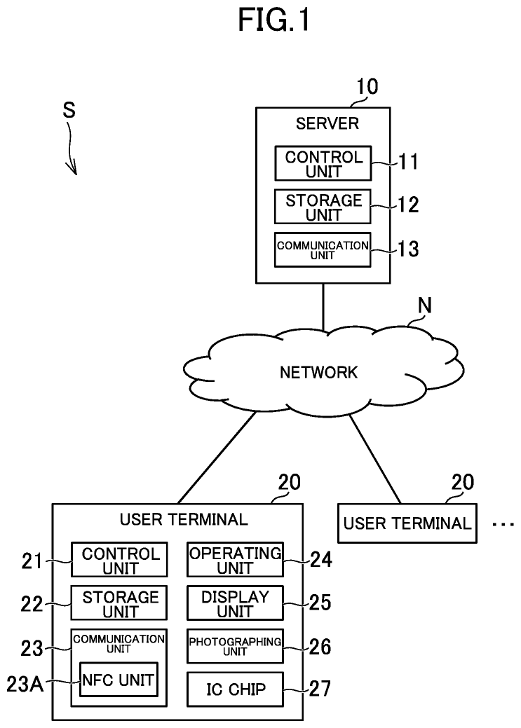

FIG. 1 is a diagram for illustrating an example of an overall configuration of the fraud detection system. As illustrated in FIG. 1, a fraud detection system S includes a server 10 and user terminals 20. Each of the server 10 and the user terminals 20 can be connected to a network N such as the Internet. It is sufficient that the fraud detection system S includes at least one computer, and is not limited to the example of FIG. 1. For example, there may be a plurality of servers 10. There may be only one user terminal 20, or there may be three or more user terminals 20.

The server 10 is a server computer. The server 10 includes a control unit 11, a storage unit 12, and a communication unit 13. The control unit 11 includes at least one processor. The storage unit 12 includes a volatile memory such as a RAM, and a nonvolatile memory such as a hard disk drive. The communication unit 13 includes at least one of a communication interface wired for communication or a communication interface for wireless communication.

The user terminal 20 is a computer of a user. For example, the user terminal 20 is a smartphone, a tablet computer, a wearable terminal, or a personal computer. The user terminal 20 includes a control unit 21, a storage unit 22, a communication unit 23, an operating unit 24, a display unit 25, a photographing unit 26, and an IC chip 27. Physical configurations of the control unit 21 and the storage unit 22 are the same as those of the control unit 11 and the storage unit 12, respectively.

The physical configuration of the communication unit 23 may be the same as that of the communication unit 13, but the communication unit 23 in the first embodiment further includes a near field communication (NFC) unit 23A. The NFC unit 23A includes a communication interface for NFC. For NFC itself, various standards can be used, and international standards, for example, ISO/IEC 18092 or ISO/IEC 21481 can be used. The NFC unit 23A includes hardware including an antenna conforming to the standards, and implements, for example, a reader/writer function, a peer-to-peer function, a card emulation function, a wireless charging function, or a combination thereof.

The operating unit 24 is an input device such as a touch panel. The display unit 25 is a liquid crystal display or an organic EL display. The photographing unit 26 includes at least one camera. The IC chip 27 is a chip that supports NFC. The IC chip 27 may be a chip of any standards, for example, a chip of Felica (trademark) or a chip of a so-called Type A or Type B among the non-contact type standards. The IC chip 27 includes hardware including an antenna conforming to the standards, and stores, for example, information required for a service to be used by a user.

At least one of programs or data stored in the storage units 12 and 22 may be supplied thereto via the network N. Further, at least one of the server 10 or the user terminal 20 may include at least one of a reading unit (e.g., an optical disc drive or a memory card slot) for reading a computer-readable information storage medium, or an input/output unit (e.g., a USB port) for inputting and outputting data to/from an external device. For example, at least one of the program or the data stored in the information storage medium may be supplied through intermediation of at least one of the reading unit or the input/output unit.

### [1-2. Outline of First Embodiment]

The fraud detection system S detects fraud in a service provided to the user. As used herein, fraud refers to an illegal act, an act that violates terms of the service, or some other act causing a nuisance. In this embodiment, a case in which the act of logging in with the user ID and password of another person and using the service by impersonating the another person corresponds to fraud is taken as an example. Accordingly, such an act as used in the first embodiment can be read as “fraud.” The fraud detection system S can detect various types of fraud. Examples of other types of fraud are described in the modification examples described later.

To detect fraud is to estimate or determine presence or absence of fraud. For example, outputting information indicating whether or not there is fraudulent, or outputting a score indicating a level of suspicion of fraud corresponds to detecting fraud. For example, when the score is represented numerically, a higher score indicates a higher suspicion of fraud. In addition to numbers, the score may be expressed by characters, for example, “S rank,” “A rank,” and “B rank.” The score can also be a probability or a likelihood of fraud.

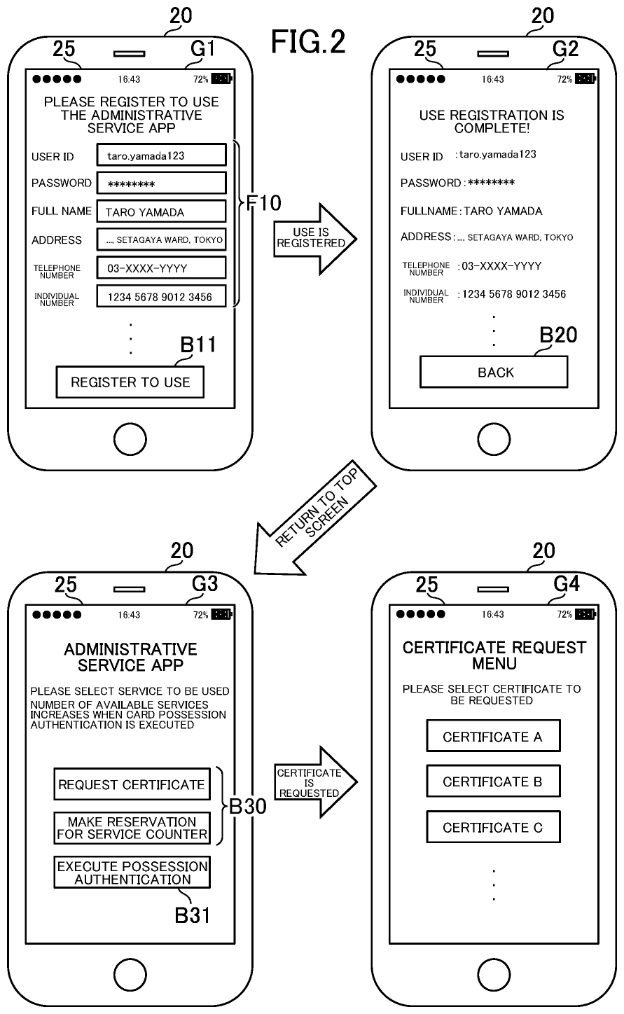

In the first embodiment, an administrative service provided by a public institution such as a government agency is described as an example of the service. Other examples of the service are described in the modification examples. In the first embodiment, the administrative service is referred to simply as “service.” In the first embodiment, a case in which the server 10 provides the service and detects fraud is described, but the service may be provided by a computer other than the server 10. An application (hereinafter referred to simply as “app”) of the public institution is installed on the user terminal 20. When the user uses the service for the first time, the user registers to use the service, and is issued with a user ID required for logging in to the service. FIG. 2 is a view for illustrating an example of a flow of use registration. As illustrated in FIG. 2, when the user starts the app of the user terminal 20, a registration screen G1 for inputting information required for use registration is displayed on the display unit 25. For example, in an input form F10, the user inputs information including a desired user ID, a password, a full name, an address, a telephone number, and an individual number of the user. The user ID is information that can uniquely identify the user in the service. The individual number is information that can identify the individual written on an individual number card issued by the public institution. In the first embodiment, the individual number card is referred to simply as “card.” When the user selects a button B11, the information input in the input form F10 is transmitted to the server 10, and a completion screen G2 indicating that the use registration is complete is displayed on the display unit 25. When the use registration is complete, the user can use the service from the app. For example, when the user selects a button B20, a top screen G3 of the app is displayed on the display unit 25. For example, on the top screen G3, a list of services usable from the app is displayed. For example, when the user selects a button B30, a use screen G4 for using services such as requesting a certificate or making a reservation for a service counter is displayed on the display unit 25.

A third party may fraudulently obtain the user ID and the password by phishing, for example. In this case, the third party may impersonate another person, log in to the service, and fraudulently use the service. To deal with the problem, in the first embodiment, possession authentication using a card is executed in order to suppress fraudulent use by a third party. Possession authentication is authentication using a possession that is possessed by only the valid person. The possession may be any possession, and is not limited to a card. For example, the possession may be an information storage medium or a piece of paper. The possession is not limited to a tangible object, and may be an intangible object such as electronic data, for example.

The user can freely choose whether or not to execute possession authentication. The users can also use services without executing possession authentication. However, under a state in which possession authentication is not executed, the services available to the user are restricted. When the user executes possession authentication from the user terminal 20 of the user, the types of services available from the user terminal 20 increase. However, even when login is executed from another user terminal 20 by using the user ID of a user who has executed possession authentication, unless possession authentication is executed on that another user terminal 20, the services available from the another user terminal 20 are restricted.

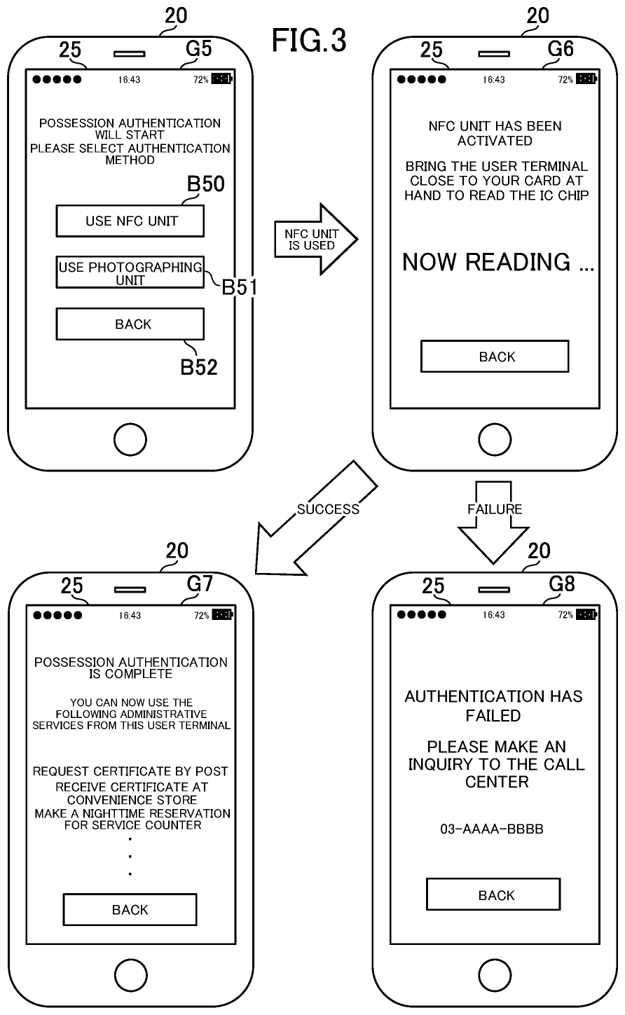

FIG. 3 is a view for illustrating an example of a flow of possession authentication. When a button B31 of the top screen G3 of FIG. 2 is selected, a start screen G5 for starting possession authentication is displayed on the display unit 25 as illustrated in FIG. 3. In the first embodiment, as the possession authentication, two types of authentication, that is, NFC authentication utilizing NFC and image authentication utilizing an image are prepared. The NFC authentication is possession authentication to be executed by causing the NFC unit 23A to read information recorded on the IC chip of the card. The image authentication is possession authentication to be executed by causing the photographing unit 26 to photograph the card. The NFC authentication and the image authentication are hereinafter referred to simply as “possession authentication” unless distinguished therebetween.

In FIG. 3, a flow of the NFC authentication is illustrated. When the user selects a button B50 on the start screen G5, the NFC unit 23A is activated, and a reading screen G6 for causing the NFC unit 23A to read the information recorded on the IC chip of the card is displayed on the display unit 25. Possession authentication may be executed at the time of use registration, and in that case, the reading screen G6 may be displayed at the time of use registration. When the reading screen G6 is displayed, the user brings the user terminal 20 closer to the card possessed by the user.

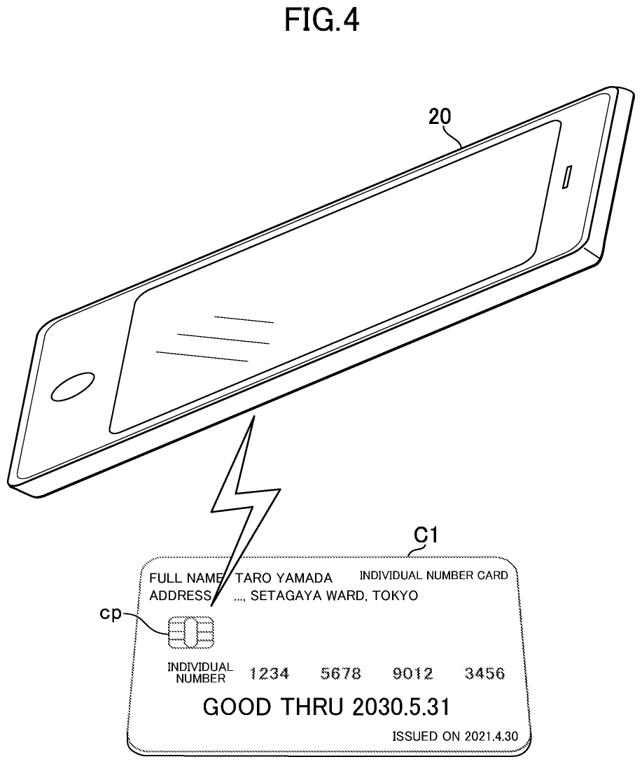

FIG. 4 is a view for illustrating an example of how the NFC unit 23A reads the IC chip of the card. A card C1 of FIG. 4 is an imaginary card prepared for the description of the first embodiment. As illustrated in FIG. 4, when the user brings the user terminal 20 closer to an IC chip cp of the card C1, the NFC unit 23A reads the information recorded on the IC chip cp. The NFC unit 23A can read any information in the IC chip cp. In the first embodiment, a case in which the NFC unit 23A reads an individual number recorded on the IC chip cp is described.

The user terminal 20 transmits the individual number read from the IC chip cp to the server 10. The individual number is input from the user terminal 20 to the server 10, and is hence hereinafter referred to as “input individual number.” In the first embodiment, input means transmitting some sort of data to the server 10. In the server 10, the individual number to be used as a correct answer is registered in advance at the time of use registration. This individual number is hereinafter referred to as “registered individual number.” In the following description, the input individual number and the registered individual number may be referred to simply as “individual number” unless particularly distinguished therebetween.

The server 10 receives the input individual number from the user terminal 20. When the user is the valid owner of the card C1, the input individual number matches the registered individual number of the logged-in user. When the input individual number matches the registered individual number of the logged-in user, a success screen G7 indicating that the possession authentication is successful is displayed on the display unit 25 as illustrated in FIG. 3. As illustrated on the success screen G7, there is an increased number of services that are available from the user terminal 20 for which possession authentication has been successful.

Meanwhile, when the input individual number does not match the registered individual number of the logged-in user, a failure screen G8 indicating that possession authentication has failed is displayed on the display unit 25. In this case, the services available from the user terminal 20 remain restricted. The user returns to the reading screen G6 and executes the reading of the card C1 again or makes an inquiry to a call center. When a third party has fraudulently logged in, the third party does not have the card C1 at hand, and possession authentication is not successful. As a result, the services available from the user terminal 20 of the third party are restricted.

Image authentication is also executed based on a similar flow. In NFC authentication, the input individual number is acquired by using the NFC unit 23A, whereas in image authentication, the input individual number is acquired by using a photographed image obtained by photographing the card C1. For example, when the user selects a button B51 of the start screen G5, the photographing unit 26 is activated. The photographing unit 26 photographs the card C1. The user terminal 20 transmits the photographed image to the server 10. The server 10 receives the photographed image, and executes optical character recognition on the photographed image to acquire the input individual number. The flow after the input individual number is acquired is the same as in NFC authentication.

The optical character recognition may be executed by the user terminal 20. Moreover, the method of acquiring the input individual number from the photographed image is not limited to optical character recognition, and as the method itself, various known methods may be applied. For example, when a code including the input individual number (for example, a bar code or a two-dimensional code) is formed on the card C1, the input individual number may be acquired by using the code photographed in the photographed image. The processing for acquiring the input individual number from the code may be executed by the server 10 or executed by the user terminal 20.

As described above, in the first embodiment, there are more services available from a user terminal 20 for which possession authentication has been successful than the services available from a user terminal 20 for which possession authentication has not been successful. Even when a third party fraudulently obtains a user ID and a password and fraudulently logs in, the third party does not possess the card C1 and possession authentication is not successful, and therefore the available services are restricted. For this reason, fraudulent use of the services by a third party is suppressed, and the security of the services is enhanced.

However, even when fraudulent use of services by a third party is suppressed, the third party may fraudulently use a service from among a small number of types of services. For example, in the example of FIG. 2, a third party may impersonate another person and request a certificate or make a reservation for a service counter. To deal with the problem, in the first embodiment, a learning model for detecting fraud in a service is used to detect fraud by a third party.

The learning model is a model which uses machine learning. Machine learning is sometimes called “artificial intelligence.” As the machine learning itself, it is possible to use various known methods, and it is possible to use, for example, a neural network. In a broad sense, deep learning and reinforcement learning are also classified as machine learning, and hence the learning model may be a model created by using deep learning or reinforcement learning. The learning model may be a model of a rule or decision tree that uses machine learning. In this embodiment, supervised learning is taken as an example, but unsupervised learning or semi-supervised learning may be used.

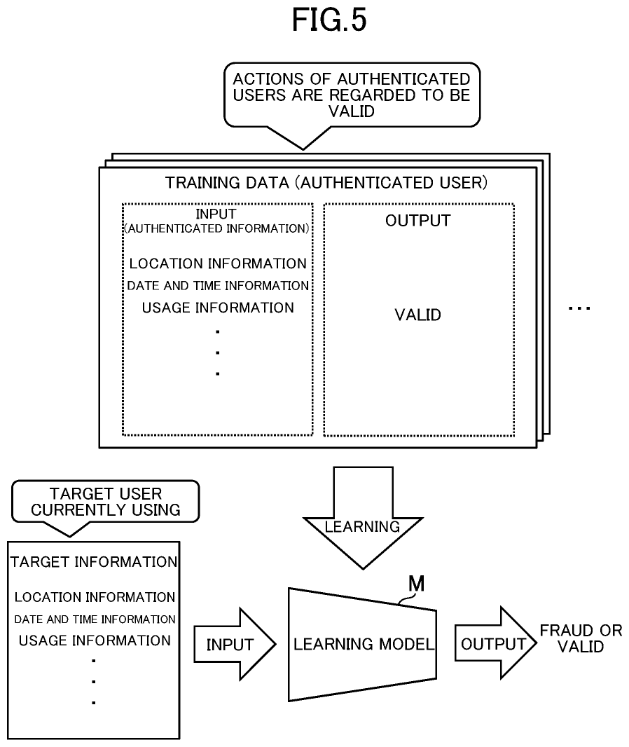

The learning model in the first embodiment can detect not only fraud by a third party who has fraudulently logged in by using the user ID of another person, but also fraud by a user who has logged in by using his or her own user ID. For example, a user may log in to a service by using his or her own user ID, request a large number of certificates for mischievous purposes, or make a reservation for a service counter and cancel without notice. When there is a certain trend in the actions of the user who performs such fraud, the learning model can detect the fraud by learning this trend. FIG. 5 is a diagram for illustrating an example of the learning model. As illustrated in FIG. 5, in the first embodiment, a learning model M using supervised learning is taken as an example. In supervised learning, training data defining a relationship between an input to the learning model M and an ideal output to be acquired from the learning model M is learned by the learning model M. There is described a case in which the learning model M in the first embodiment outputs a first value indicating that an action is fraudulent or a second value indicating that an action is valid, but a score indicating suspicion of fraud may be output. A case of outputting a score is described in the modification examples described later. The learning model M in the first embodiment classifies whether or not an action is fraudulent. That is, the learning model M labels whether or not an action is fraudulent.

The training data is often created manually by a creator of the learning model M. In order to increase the accuracy of the learning model M, it is required to prepare a large amount of training data. It is very time-consuming for an administrator to manually create all of the training data. For example, the administrator is required to create the training data by determining whether each action in the service is a valid action or a fraudulent action.

In this regard, the user who has executed possession authentication possesses the physical card required to execute the possession authentication, and therefore the probability that the user is not performing fraud is very high. Even when a user performing fraud can fraudulently obtain the user ID and the password by phishing, for example, the probability of the user using the service without being able to steal the physical card and execute possession authentication is very high. Even in a case in which the user performing fraud can steal the physical card, when the user who has executed the possession authentication performs fraud, it is easy to identify who has performed the fraud, and hence there is a very high probability that the user performing fraud uses the service without executing possession authentication in order to hide his or her identity. For example, a user performing fraud may complete the usage registration by inputting a number other than his or her own individual number as the individual number. In a case in which the service is provided in the flow illustrated in FIG. 2 and FIG. 3, even when a number other than his or her own individual number is input, the service can be used within the restricted range.

Thus, in the first embodiment, the training data is created by regarding the action of the user who has executed the possession authentication as valid. The user who has executed possession authentication is hereinafter referred to s “authenticated user.” As illustrated in FIG. 5, the training data in the first embodiment is created based on actions of the authenticated user. In the example of FIG. 5, the training data includes an input portion including location information, date and time information, and usage information, and an output portion indicating that the action is valid.

The location information indicates the location of the user terminal 20. The location may be indicated by any information, and is indicated by, for example, latitude and longitude, address, mobile base station information, wireless LAN access point information, or IP address. The location information may be the distance from a central place at which the service is normally used. The central place may be an average value of the locations used from a certain user ID, or may be an average value of the locations used from a certain user terminal 20. The date and time information indicates the date and time when the service is used. The usage information indicates how the service was used. The usage information can also be referred to as a usage history of the service. For example, the usage information indicates the type of the service used, the content of the use, the operation of the user, or a combination thereof.

For example, the server 10 detects the fraud of the user logged in to the service by using the trained learning model M. The user who is the target of fraud detection is hereinafter referred to as “target user.” Target information including location information, date and time information, and usage information on the target user is input to the learning model M. The learning model M outputs an estimation result of whether or not the action is fraud based on the target information. When the output from the learning model M indicates fraud, the provision of services to the target user is restricted. When the output from the learning model M indicates that the action is valid, the provision of the service to the target user is not restricted.

As described above, the fraud detection system S of the first embodiment creates training data to be learned by the learning model M using supervised learning based on authenticated information on an authenticated user having a very high probability that he or she is not performing fraud. As a result, this saves the creator of the learning model M from expending time and effort to manually create training data, and simplifies the creation of the learning model M. In the following, the details of the first embodiment are described.

[1-3. Functions implemented in First Embodiment]

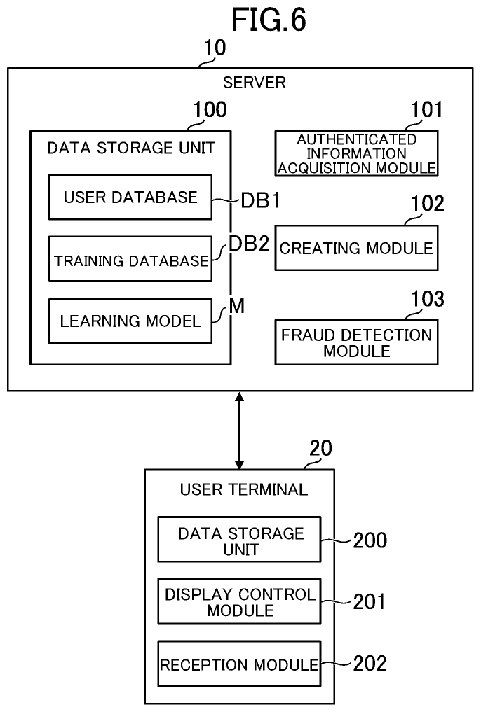

FIG. 6 is a functional block diagram for illustrating an example of functions implemented by the fraud detection system S according to the first embodiment. In this case, the functions implemented on each of the server 10 and the user terminal 20 are described.

[1-3-1. Functions implemented on Server]

As illustrated in FIG. 6, on the server 10, a data storage unit 100, an authenticated information acquisition module 101, a creating module 102, and a fraud detection module 103 are implemented. The data storage unit 100 is implemented mainly by the storage unit 12. Each of the authenticated information acquisition module 101, the creating module 102, and the fraud detection module 103 is mainly implemented by the control unit 11.

### [Data Storage Unit]

The data storage unit 100 stores data required for creating the learning model M. For example, a user database DB1, a training database DB2, and the learning model M are stored in the data storage unit 100.

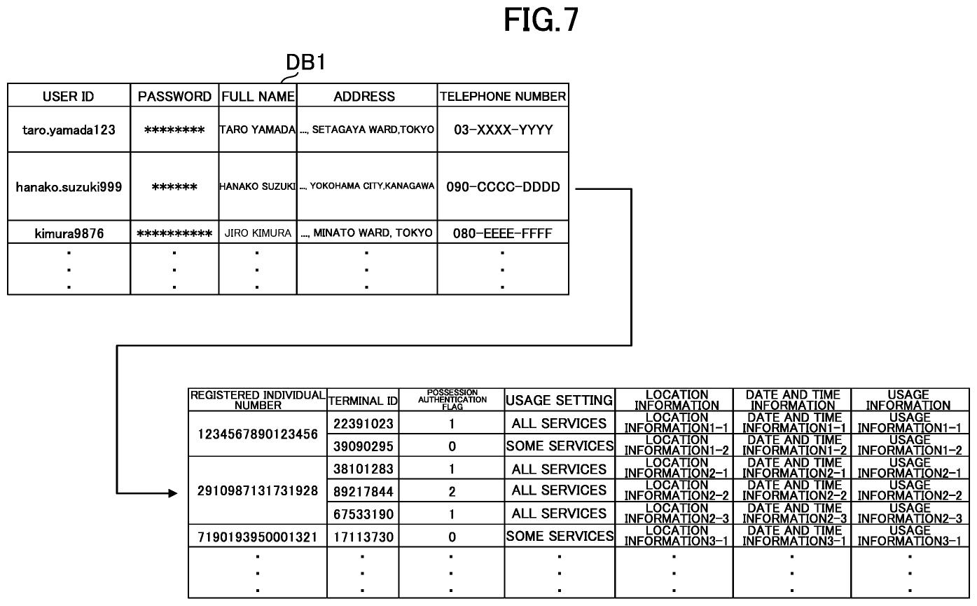

FIG. 7 is a table for showing a data storage example of the user database DB1. As shown in FIG. 7, the user database DB1 is a database in which information relating to users who have completed use registration is stored. For example, the user database DB1 stores a user ID, a password, a full name, an address, a telephone number, a registered individual number, a terminal ID, a possession authentication flag, a service usage setting, location information, date and time information, and usage information.

For example, when the user has performed a use registration, a new record is created in the user database DB1. The record stores the user ID, password, full name, address, telephone number, and registered individual number that have been designated at the time of use registration. In the first embodiment, the registered individual number is not changeable after the use registration. Thus, even when a third party fraudulently logs in, the third party is not able to change the registered individual number by themselves. A confirmation of the individual number is not performed at the time of the use registration, and therefore a user performing fraud may complete the use registration by inputting a number other than his or her own individual number as the individual number.

The terminal ID is information that can identify the user terminal 20. In the first embodiment, a case in which the server 10 issues the terminal ID is described. The terminal ID is issued based on a predetermined rule. The server 10 issues the terminal ID so as not to duplicate another terminal ID. An expiration date may be set for the terminal ID. The terminal ID can be issued at any timing. For example, the terminal ID is issued when the app is started, when the expiration date set for the terminal ID is reached, or an operation for updating the terminal ID is performed.

The user terminal 20 can be identified based on any information other than the terminal ID. For example, other than the terminal ID, the user terminal 20 can be identified based on the IP address, information stored in a cookie, an ID stored in a SIM card, an ID stored in the IC chip 27, or the individual identification information on the user terminal 20. It is sufficient that the information that can identify the user terminal 20 in some way is stored in the user database DB1.

The terminal ID associated with the user ID is the terminal ID of the user terminal 20 that has been logged in to from the user ID. Thus, when a certain user who is the valid owner of a certain user ID logs in from a new user terminal 20, the terminal ID of the new user terminal 20 is associated with the user ID> Even when a third party fraudulently logs in from this user ID, the terminal ID of the user terminal 20 of the third party is associated with the user ID.

The terminal ID is associated with a possession authentication flag, a usage setting, time information, location information, date and time information, and usage information. In the first embodiment, the information on the possession authentication flag, for example, is associated with each combination of the user ID and the terminal ID. In the example of FIG. 7, a user ID “taro.yamada123” has been logged in from two user terminals 20. A user ID “hanako.suzuki999” has been logged in from three user terminals 20. A user ID “kimura9876” has been logged in from only one user terminal 20.

The possession authentication flag is information indicating whether or not possession authentication has been executed. For example, when the possession authentication flag is “1”, this indicates that NFC authentication has been executed. When the possession authentication flag is “2”, this indicates that image authentication has been executed. When the possession authentication flag is “0”, this indicates that possession authentication has not been executed. In the first embodiment, a case in which possession authentication is not executed at the time of use registration is described, and therefore the initial value of the possession authentication flag is “0”. When possession authentication is executed after use registration, the possession authentication flag changes to “1” or “2”. In a case in which possession authentication can be executed at the time of use registration, when the user executes possession authentication at the time of use registration, the initial value of the possession authentication flag becomes “1” or “2”.

In the usage setting, the types of services that are usable from the app are shown. The usage setting when the possession authentication flag is “1” or “2” has more services that can be used than those of the usage setting when the possession authentication flag is “0”. It is assumed that the relationship between whether or not possession authentication has been executed and the usage setting (that is, the relationship between the possession authentication flag and the usage setting) is defined in advance in the data storage unit 100. In the example of FIG. 6, the usage setting when the possession authentication flag is “1” or “2” is a setting in which all services can be used. The usage setting when the possession authentication flag is “0” is a setting in which only a part of the services can be used.

Details of the location information, the date and time information, and the usage information are as described above. When a service is used in a logged-in state by a certain user ID from a certain user terminal 20, the location information, date and time information, and usage information associated with the combination of the user ID and the user terminal 20 are updated. As the method of acquiring the location information itself, a known method using GPS or a mobile base station, for example, can be used. As the method of acquiring the date and time information itself, a known method using a real-time clock, for example, can be used. As the usage information, it is sufficient that information corresponding to the service is stored, and the detailed contents of such usage information are as described above.

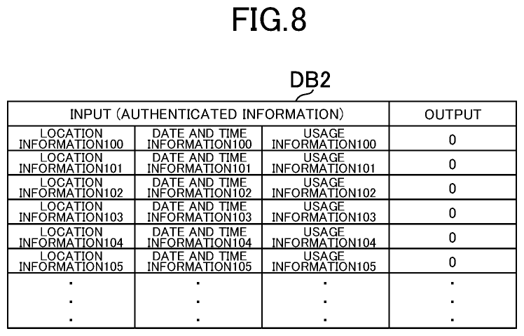

FIG. 8 is a table for showing a data storage example of the training database DB2. As shown in FIG. 8, the training database DB2 is a database in which training data to be learned by the learning model M is stored. In this embodiment, a pair of an input portion for the learning model M and an output portion to be used as the correct answer is referred to as “training data (teacher data).” In the example of the output portion of FIG. 8, valid is indicated by “0”. Fraud may be indicated by any other value, for example, “1”. A collection of those pairs is stored in the training database DB2. The details of the training data are as described with reference to FIG. 5. The training data is created by the creating module 102. A part of the training data may be created manually by the creator of the learning model M, or may be created by using a known training data creation tool.

The data storage unit 100 stores the program and a parameter of the trained learning model M. The data storage unit 100 may store the learning model M before the training data is learned and a program required for learning the training data. The data stored in the data storage unit 100 is not limited to the example described above. The data storage unit 100 can store any data.

The learning model M is a model which uses machine learning. Machine learning is sometimes called “artificial intelligence.” As the machine learning itself, it is possible to use various known methods, and it is possible to use, for example, a neural network. In a broad sense, deep learning and reinforcement learning are also classified as machine learning, and hence the learning model M may be a model created by using deep learning or reinforcement learning. In this embodiment, supervised learning is taken as an example, but unsupervised learning or semi-supervised learning may be used.

### [Authenticated Information Acquisition Module]

The authenticated information acquisition module 101 acquires authenticated information relating to the action of the authenticated user who has executed predetermined authentication from a user terminal 20 from which the predetermined service can be used. In the first embodiment, a case in which the authentication is possession authentication for confirming whether or not a predetermined card C1 is possessed by using the user terminal 20 is taken as an example. Accordingly, possession authentication as used herein can be read as “predetermined authentication.” That is, NFC authentication or image authentication as used herein can be read as “predetermined authentication.” In the first embodiment, a case in which the authenticated user is the user who has executed possession authentication from the user terminal 20 is described, but it is sufficient that the authenticated user is a user who has executed predetermined authentication from the user terminal 20.

The predetermined authentication is authentication that can be executed from the user terminal 20. The predetermined authentication may be the authentication at login, but in the first embodiment, the predetermined authentication is different from the authentication at login. The predetermined authentication is not limited to possession authentication using the card C1. Various authentication methods can be used for the predetermined authentication. For example, the predetermined authentication may be possession authentication for confirming a possession other than the card C1. The possession may be anything that can be used to confirm the identity of the user. For example, the possession may be an identification certificate, for example a passport, other than a card, an information storage medium in which some sort of authentication information is recorded, or a piece of paper on which some sort of authentication information is formed. For example, the possession may be an electronic object such as a code including authentication information.

The predetermined authentication is not limited to possession authentication. For example, the predetermined authentication may be knowledge authentication, such as password authentication, passcode authentication, personal identification number authentication, or countersign authentication. When the predetermined authentication is password authentication, a password different from the password used at login is used. As another example, the predetermined authentication may be biometric authentication, such as face authentication, fingerprint authentication, or iris authentication. In the first embodiment, a case in which the predetermined authentication is more secure than the authentication at login is described, but the authentication at login may be more secure than the predetermined authentication. The authentication at login is not limited to password authentication, and may be any authentication method.

The card C1 used in the possession authentication in the first embodiment includes an input individual number to be used in the possession authentication. For example, the input individual number is electronically recorded on the IC chip cp of the card C1. In the first embodiment, the input individual number is also formed on the surface of the card C1. The registered individual number, which is to be used as the correct answer in the possession authentication, is registered in the user database DB1. Each of the input individual number and the registered individual number is an example of the authentication information used at the time of authentication.

When another authentication method is used as the predetermined authentication, it is sufficient that authentication information corresponding to the authentication method is used. For example, when knowledge authentication is used, the authentication information may be a password, a passcode, a personal identification number, or a countersign. When biometric authentication is used, each piece of the authentication information may be a facial photograph, a facial feature amount, a fingerprint pattern, or an iris pattern.

For example, when the possession authentication is executed by using NFC authentication, the server 10 acquires the input individual number of the card C1 acquired by using the NFC unit 23A from the user terminal 20. The server 10 refers to the user database DB1, and determines whether or not the input individual number acquired from the user terminal 20 and the registered individual number associated with the logged-in user match. When those numbers match, possession authentication is successful. When those numbers do not match, possession authentication fails.

For example, when the possession authentication is executed by using image authentication, the server 10 acquires a photographed image of the card C1 from the user terminal 20. The server 10 uses optical character recognition to acquire the input individual number from the photographed image. The flow of the possession authentication after the input individual number is acquired is the same as for NFC authentication. In the first embodiment, a case in which the input individual number is printed on the surface of the card C1 is described, but the input individual number may be formed as unevenness embossed on the surface of the card C1. It is sufficient that the input individual number is formed on at least one of the front surface or the back surface of the card C1.

The service in the first embodiment can be logged in from each of the plurality of user terminals 20 by using the same user ID. The authentication module 101 can execute, for each user terminal 20, possession authentication in a logged-in state from each of those user terminals 20 to the service by the user ID. For example, it is assumed that the user having the user ID “taro.yamada123” of FIG. 7 is using two user terminals 20. Those two user terminals 20 are referred to as “first user terminal 20A” and “second user terminal 20B.”

The server 10 can execute possession authentication from the first user terminal 20A in a logged-in state to the service by the user ID “taro.yamada123.” The authentication module 101 can execute possession authentication from the second user terminal 20B in a logged-in state to the service by the same user ID “taro.yamada123.” Similarly, when one user uses three or more user terminals 20, the authentication module 101 can execute possession authentication for each user terminal 20. As described above, whether or not possession authentication is to be executed is up to the user, and therefore it is not required that possession authentication be executed on all the user terminals 20.

Authenticated information is information relating to an action of an authenticated user. The action is the content of an operation performed on the user terminal 20, information transmitted from the user terminal 20 to the server 10, or a combination thereof. In other words, an action is information indicating how a service is used. In the first embodiment, a combination of the location information, date and time information, and usage information corresponds to the information relating to the action. The combination of the location information, date and time information, and usage information on an authenticated user is an example of authenticated information. Thus, this combination is hereinafter referred to as “authenticated information.”

The authenticated information is not limited to the example of the first embodiment, and may be any information relating to some sort of action of the authenticated user. That is, the authenticated information may be a feature having some sort of correlation with whether or not the action is fraudulent. For example, the authenticated information may be a period of time from the user logging in until a predetermined screen is reached, the number or type of screens displayed until the predetermined screen is reached, the number of operations performed on a certain screen, a tracking history of a pointer, or a combination thereof. The authenticated information may be any information corresponding to the service. Other examples of the authenticated information are described in the modification examples later.

In the first embodiment, the authenticated information is stored in the user database DB1. In the example of FIG. 7, the combination of the location information, date and time information, and usage information stored in records having a possession authentication flag of “1” or “2” corresponds to the authenticated information. The authenticated information acquisition module 101 refers to the user database DB1, and acquires the authenticated information. In the first embodiment, a case in which the authenticated information acquisition module 101 acquires a plurality of pieces of authenticated information, but it is sufficient that the authenticated information acquisition module 101 acquires at least one piece of authenticated information.

In the first embodiment, a case which the authenticated information acquisition module 101 acquires the authenticated information having a date and time indicated by the date and time information included in the latest predetermined period (for example, from about one week to about one month) s described, but all the authenticated information stored in the user database DB1 may be acquired. The authenticated information acquisition module 101 is not required to acquire all the authenticated information within the predetermined period, and may randomly select and acquire a part of the authenticated information within the predetermined period. It suffices that the authenticated information acquisition module 101 acquires a number of pieces of authenticated information that is sufficient for the learning of the learning model M.

### [Creating Module]

The creating module 102 creates, based on the authenticated information, the learning model M for detecting fraud in a service such that the action of the authenticated user is estimated to be valid. Creating the learning model M means the learning model M performs learning. Adjusting the parameter of the learning model M corresponds to creating the learning model M. The parameter itself may be any known parameter used in machine learning, and is, for example, a weighting coefficient or a bias. As the learning method itself of the learning model M, it is possible to use various methods, and it is possible to use, for example, a method of deep learning or reinforcement learning. Further, for example, a gradient descent method may be used, or a backpropagation method may be used for deep learning.

In the first embodiment, the learning model M is a supervised learning model. The creating module 102 creates, based on the authenticated information, training data indicating that the action of the authenticated user is valid. This training data is an example of first training data. In the modification examples described later, other training data is described, and therefore the different types of training data, for example, first training data and second training data, are distinguished from each other, but in the first embodiment, other training data is not described, and therefore the first training data is simply referred to as “training data.”

For example, the creating module 102 creates training data including an input portion which is authenticated information and an output portion indicating that the action is valid. The input portion can be expressed in any format, for example, in a vector format, an array format, or as a single number. It is assumed that the input portion is obtained by quantifying items included in the location information, date and time information, and usage information included in the authenticated information. The quantifying may be performed inside the learning model M. The input portion corresponds to a feature amount of the action. The output portion corresponds to the correct answer of the output of the learning model M.

The creating module 102 creates training data for each piece of authenticated information, and stores the created training data in the training database DB2. The creating module 102 creates the learning model M by training the learning model M based on the training data. The creating module 102 trains the learning model M such that the output portion of the training data is acquired when the input portion of the training data is input. The creating module 102 may create a learning model M by using all the training data stored in the training database DB2, or may create a learning model M by using only a part of the training data.

### [Fraud Detection Module]

The fraud detection module 103 detects fraud by using the created learning model M. When the target user logs in to a service, the fraud detection module 103 acquires the location information, date and time information, and usage information on the target user, and stores the acquired information in the user database DB1. The combination of those pieces of information is the target information illustrated in FIG. 5. When the timing for predetermined fraud detection arrives, the fraud detection module 103 acquires the output of the learning model M based on the target information on the target user. In the first embodiment, a case in which the fraud detection module 103 inputs the target information to the learning model M and acquires the output from the learning model M is described, but the fraud detection module 103 may execute some sort of calculation or quantification processing on the target information, and then input the target information on which such processing has been executed to the learning model M.

The fraud detection module 103 restricts the provision of services to the target user, that is, use of services by the target user, when the output of the learning model M indicates fraud. The fraud detection module 103 does not restrict the use of services by the target user when the output indicates that the action is valid. The fraud detection may be executed at any timing, for example, when the button B30 of the top screen G3 is selected, when the information registered in the user database DB1 is changed, when a service is logged into, or when some sort of payment processing is executed.

[1-3-2. Functions implemented on User Terminal]

As illustrated in FIG. 5, on the user terminal 20, a data storage unit 200, a display control module 201, and a reception module 202 are implemented. The data storage unit 200 is implemented mainly by the storage unit 22. Each of the display control module 201 and the reception module 202 is implemented mainly by the control unit 21. The data storage unit 200 stores data required for processing described in the first embodiment. For example, the data storage unit 200 stores an app. The display control module 201 causes the display unit 25 to display each of the screens described with reference to FIG. 2 and FIG. 3 based on the app. The reception module 202 receives the user's operation on each screen. The user terminal 20 transmits the content of the operation of the user to the server 10. Further, for example, the user terminal 20 transmits the location information, for example, required for acquiring the authenticated information.

### [1-4. Processing to be Executed in First Embodiment]

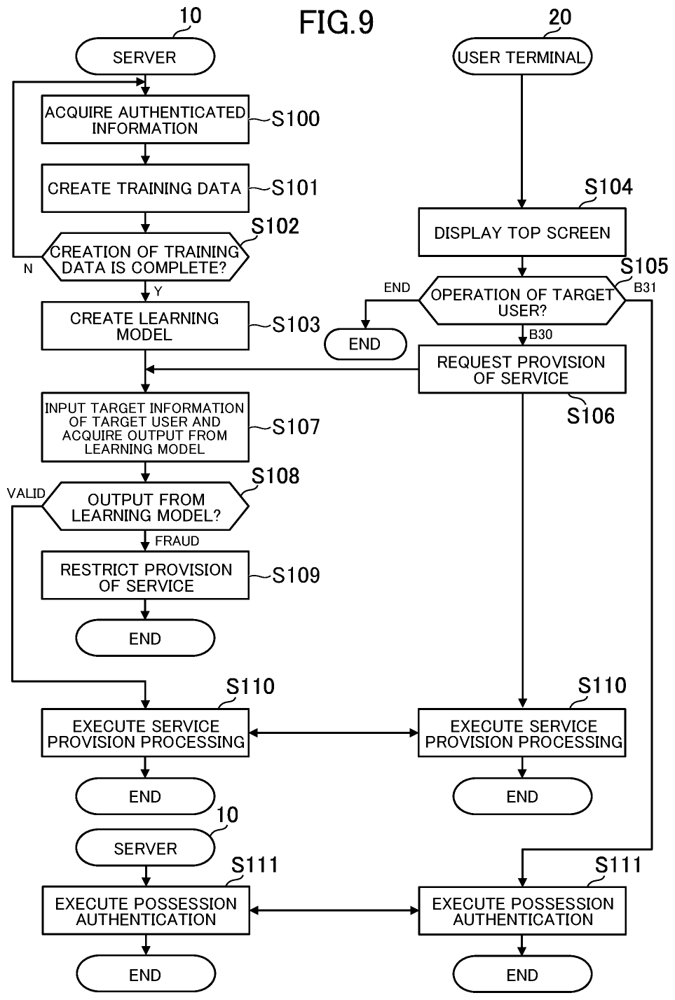

FIG. 9 is a flow chart for illustrating an example of processing to be executed in the first embodiment. The processing illustrated in FIG. 9 is executed by the control units 11 and 21 operating in accordance with the programs stored in the storage units 12 and 22, respectively. This processing is an example of processing to be executed by the functional blocks illustrated in FIG. 6. It is assumed that, before the execution of execution of this processing, the use registration by the user is complete. It is assumed that the user terminal 20 stores the terminal ID issued by the server 10 in advance.

As illustrated in FIG. 9, the server 10 acquires the authenticated information on the authenticated user based on the user database DB1 (Step S100). In Step S100, the server 10 acquires the authenticated information stored in the records having a possession authentication flag of “1” or “2” and having a date and time indicated by the date and time information included in the latest predetermined period.

The server 10 creates training data based on the authenticated information acquired in Step S100 (Step S101). In Step S101, the server 10 creates training data including an input portion which is authenticated information and an output portion indicating fraud, and stores the training data in the training database DB2. The server 10 determines whether or not the creation of training data is complete (Step S102). In Step S102, the server 10 determines whether or not a predetermined number of pieces of training data have been created.

When it is not determined that the creation of training data is complete (“N” in Step S102), the process returns to Step S100. Then, a new piece of training data is created, and the training data is stored in the training database DB2. When it is determined in Step S102 that the creation of training data is complete (“Y” in Step S102), the server 10 creates the learning model M based on the training database DB2 (Step S103). In Step S103, the server 10 causes the learning model M to learn each piece of training data such that when the input portion of each piece of training data stored in the training database DB2 is input, the output portion of the training data is output.

When the learning model M is created in Step S103, the learning model M can be used to detect fraud in a service. The user terminal 20 activates the app based on the operation of the target user, and displays the top screen G3 on the display unit 25 (Step S104). When the app is started, login may be executed between the server 10 and the user terminal 20. At login, input of the user ID and the password may be required, or information indicating that the user has logged in in the past may be stored in the user terminal 20, and that information may be used for login. When the user terminal 20 subsequently accesses the server 10 in some way, the location information, date and time information, and usage information associated with the terminal ID of the user terminal 20 are updated as appropriate. The server 10 may also generate, before login is successful and the top screen G3 is displayed, the display data of such a top screen G3 that the button B30 of unusable services are not selectable based on the usage setting associated with the terminal ID of the user terminal 20, and transmit the generated display data to the user terminal 20.

The user terminal 20 identifies the operation of the target user based on a detection signal of the operating unit 24 (Step S105). In Step S105, any one of the button B30 for using an administrative service and the button B31 for executing possession authentication is selected. When the user terminal 20 has already executed possession authentication, the button B31 may not be selectable. When the target user performs an operation for ending the app or an operation for causing the app to transition to the background (“end” in Step S105), this process ends.

In Step S105, when the button B30 is selected (“B30” in Step S105), the user terminal 20 requests the server 10 to provide the type of service selected by the target user from the button B30 (Step S106). The server 10 inputs the target information on the target user to the learning model M, and acquires the output from the learning model M (Step S107). The case described here is a case in which the processing step of Step S107 is executed after the target user logs in, but the processing step of Step S107 may be executed when the target user logs in. In this case, it is possible to detect a fraudulent login and prevent fraudulent login from occurring. The target information is the location information, date and time information, and usage information on the target user (that is, the logged-in user). When the target user has in the past logged in from a plurality of user terminals 20, the output from the learning model M is acquired based on the target information associated with the terminal ID of the currently logged-in user terminal 20.

The server 10 refers to the output from the learning model M (Step S108). When the output from the learning model M indicates fraud (“fraud” in Step S108), the server 10 restricts the provision of services (Step S109). In Step S109, the server 10 does not provide the type of service selected by the user. An error message is displayed on the user terminal 20. When the output from the learning model M indicates valid (“valid” in Step S108), service provision processing for providing the service is executed between the server 10 and the user terminal 20 (Step S110), and this process ends. In Step S110, the server 10 refers to the user database DB1, and acquires the usage setting associated with the user ID of the logged-in user and the terminal ID of the user terminal 20. The server 10 provides the service based on the usage setting. The server 10 receives the content of the operation of the user from the user terminal 20, and executes the processing corresponding to the operation content.

In Step S105, when the button B31 is selected (“B31” in Step S108), the user terminal 20 displays the start screen G5 on the display unit 25, possession authentication is executed between the server 10 and the user terminal 20 (Step S111), and this process ends. When NFC authentication is selected in Step S111, the user terminal 20 transmits the input individual number read by the NFC unit 23A to the server 10. The server 10 receives the input individual number, refers to the user database DB1, and determines whether or not the received input individual number and the registered individual number of the logged-in user match. When those numbers do match, the server 10 determines that possession authentication is successful, sets the possession authentication flag to “1”, and changes the usage setting such that the service usage restriction is lifted. When image authentication has been selected, the input individual number is acquired from the photographed image, and image authentication is executed based on the same flow as for NFC authentication. In this case, the possession authentication flag is “2”.

According to the fraud detection system S of the first embodiment, the learning model M is created based on the authenticated information such that the action of an authenticated user is estimated to be valid. Through focusing on the very high probability that authenticated users are valid, the learning model M can be created without the creator of the learning model M manually creating the training data, and as a result, the creation of the learning model M can be simplified. Further, a series of processes from the creation of the training data to the learning of the learning model M can be automated, and the learning model M can be created quickly. A learning model M which has learned the latest trend can be quickly applied to the fraud detection system S, and fraud can be accurately detected. As a result, fraudulent use in the service is prevented and security is increased. Moreover, it is also possible to prevent a decrease in convenience, for example, a situation in which the action of a target user who is actually a valid user is estimated to be fraud and as a result the service is not usable by the user. Even when the learning model M learns only the valid actions of the authenticated user, fraud actions often have different characteristics from those of valid actions. As a result, the learning model M can detect fraud by detecting actions having different characteristics from those of the valid actions.

Further, by creating the learning model M by using the authenticated information on an authenticated user who has executed possession authentication, the fraud detection system S can use the authenticated information on an authenticated user having a very high probability of being valid to create a highly accurate learning model M. Through creation of a highly accurate learning model M, fraudulent use of a service can be prevented more reliably, and security can be effectively increased. It is also possible to more reliably prevent a situation in which the action of the target user who is actually a valid user is estimated to be fraudulent and as a result the service is not usable by the user.

Further, the fraud detection system S creates, based on the authenticated information, training data indicating that the action of an authenticated user is valid, and by training the learning model M based on the training data, can automatically create training data and reduce the time and effort of the creator of the learning model M. Through automation of the creation of the training data, which is one of the most time-consuming steps in creating the learning model M, the learning model M can be created quickly. As a result, fraudulent use in the service is more reliably prevented, and security is effectively increased.

### 2. Second Embodiment

Next, a second embodiment of the present disclosure is described as an example of an embodiment of a learning model M evaluating system according to the present disclosure. In the second embodiment, a case in which the learning model M evaluating system is applied to the fraud detection system S which is described in the first embodiment is taken as an example. Accordingly, the fraud detection system S as used in the second embodiment can be read as “learning model M evaluating system.” The learning model M evaluating system may perform up to the evaluation of the learning model M, and the fraud detection may be executed by another system. That is, the learning model M evaluating system is not required to include the function of fraud detection among the functions of the fraud detection system S.

Further, a case in which the learning model M is created in the same manner as in the first embodiment is described, but the learning model M in the second embodiment may be created by a method different from that in the first embodiment. For example, the learning model M may be created based on training data manually created by the creator of the learning model M. Moreover, for example, the learning model M may be created based on training data created by using a known training data creation support tool. Thus, the fraud detection system S of the second embodiment is not required to include the functions described in the first embodiment. In the second embodiment, description of points that are the same as in the first embodiment is omitted.

### [2-1. Outline of Second Embodiment]

The actions of the users in the fraud detection system S change every day, and therefore the fraud detection accuracy of the learning model M may gradually decrease unless the latest trend is learned by the learning model M. This point is the same for learning models M created by methods other than that of the first embodiment. The same applies when unsupervised learning or semi-supervised learning is used. Thus, in the second embodiment, attention is paid to the fact that the authenticated user has a very high probability of being valid, and the accuracy of the learning model M is accurately evaluated based on authenticated information.

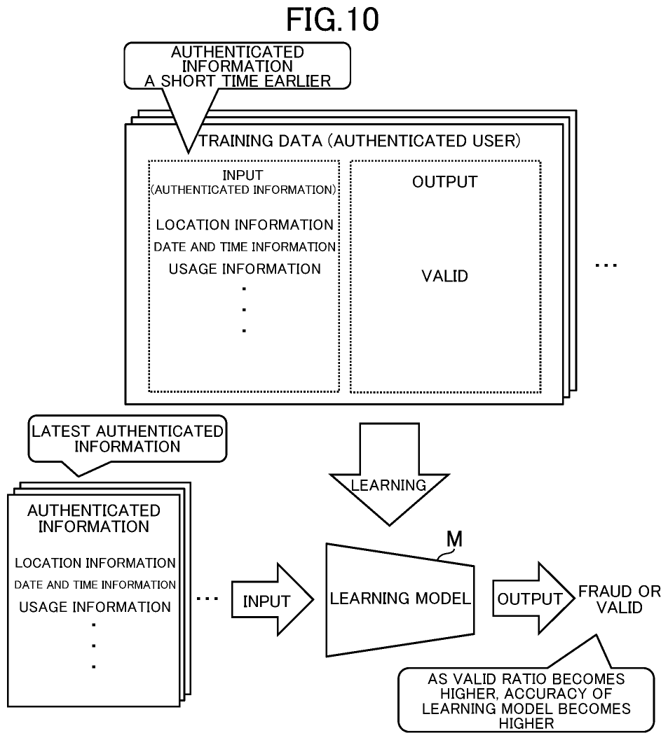

FIG. 10 is a diagram for illustrating an outline of the second embodiment. As illustrated in FIG. 10, each of a plurality of pieces of authenticated information is input to the learning model M. The authenticated information is information relating to actions of authenticated users having a very high probability of being valid, and therefore when the output from the learning model M indicates that an action is valid, it is predicted that the accuracy of the learning model M has not deteriorated. However, when the output from the learning model M indicates fraud, there is a possibility that the learning model M does not support the latest actions (i.e., valid actions) of authenticated users, and that accuracy has deteriorated. In this case, the creator of the learning model M is notified that accuracy has deteriorated, or the learning model M is created again based on the latest authenticated information.

As described above, the fraud detection system S of the second embodiment acquires an output from the learning model M based on the authenticated information, and evaluates the accuracy of the learning model M based on the output corresponding to the authenticated information. The accuracy of the learning model M can be accurately evaluated by using the authenticated information on an authenticated user having a very high probability of being valid. The details of the second embodiment are now described.

### [2-2. Functions Implemented in Second Embodiment]

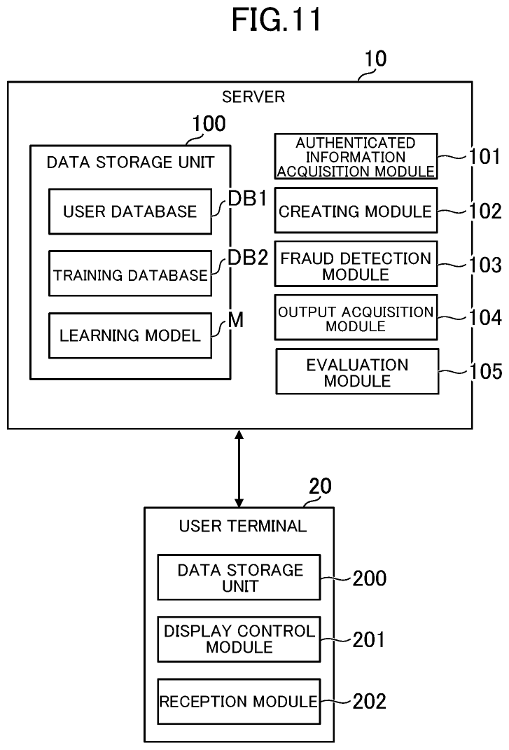

FIG. 11 is a functional block diagram for illustrating an example of functions implemented by the fraud detection system S according to the second embodiment. In this case, the functions implemented on each of the server 10 and the user terminal 20 are described.

### [2-2-1. Functions Implemented on Server]

As illustrated in FIG. 11, the server 10 includes a data storage unit 100, an authenticated information acquisition module 101, a creating module 102, a fraud detection module 103, an output acquisition module 104, and an evaluation module 105. Each of the output acquisition module 104 and the evaluation module 105 is implemented mainly by the control unit 11.

[Data Storage Unit, Authenticated Information module, and Fraud Detection Acquisition Module, Creating Module]

The data storage unit 100 is the same as that in the first embodiment. The authenticated information acquisition module 101 in the first embodiment acquires authenticated information for creating the learning model M, but the authenticated information acquisition module 101 in the second embodiment acquires authenticated information for evaluating the learning model M. The purpose of using the authenticated information is different, but the authenticated information itself is the same. The other points of the authenticated information acquisition module 101 are the same as those in the first embodiment. The creating module 102 and the fraud detection module 103 are the same as those in the first embodiment.

### [Output Acquisition Module]

The output acquisition module 104 acquires the output from the learning model M for detecting fraud in a service based on the authenticated information. For example, the output acquisition module 104 acquires the output corresponding to each of a plurality of pieces of authenticated information. The process in which the authenticated information is input to the learning model M and the output from the learning model M is acquired is as described in the first embodiment. Similarly to the first embodiment, some sort of calculation or quantification processing may be executed on the authenticated information, and then the authenticated information on which such processing has been executed may be input to the learning model M.

### [Evaluation Module]

The evaluation module 105 evaluates the accuracy of the learning model M based on the output corresponding to the authenticated information. The output corresponding to the authenticated information is the output from the learning model M acquired based on the authenticated information. The accuracy of the learning model M is an index showing the probability of a desired result being obtained from the learning model M. For example, the probability that an output indicating valid can be acquired from the learning model M when the target information on a valid action is input corresponds to the accuracy of the learning model M. The probability that an output indicating fraud can be acquired from the learning model M when the target information on a fraud action is input corresponds to the accuracy of the learning model M. The accuracy of the learning model M can be measured based on any index. For example, it is possible to use a correct answer rate, a precision rate, a reproducibility rate, an F value, a specificity, a false positive rate, a Log loss, or an area under the curve (AUC).

In the second embodiment, the evaluation module 105 evaluates that the accuracy of the learning model M is higher when the output from the learning model M corresponding to the authenticated information indicates valid than when the output from the learning model M indicates fraud. For example, the evaluation module 105 evaluates the accuracy of the learning model M based on the output corresponding to each of a plurality of pieces of authenticated information. The evaluation module 105 calculates, as the correct answer rate, the ratio of outputs from the learning model M indicating valid from among the authenticated information input to the learning model M. The evaluation module 105 evaluates that the accuracy of the learning model M is higher when the accuracy rate is higher. That is, the evaluation module 105 evaluates that the accuracy of the learning model M is lower when the accuracy rate is lower. As the accuracy of the learning model M, the various indices described above can be used instead of the correct answer rate.

### [2-2-2. Functions Implemented on User Terminal]

As illustrated in FIG. 11, the functions of the user terminal 20 are the same as in the first embodiment.

### [2-3. Processing to be Executed in Second Embodiment]

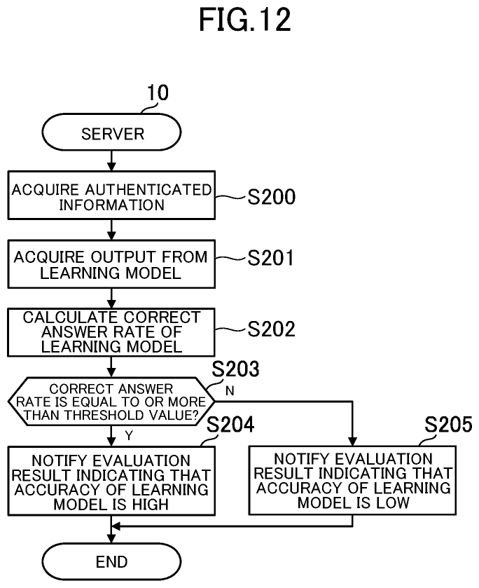

FIG. 12 is a flow chart for illustrating an example of processing to be executed in the second embodiment. The processing illustrated in FIG. 12 is executed by the control units 11 operating in accordance with the program stored in the storage units 12. This processing is an example of processing to be executed by the functional blocks illustrated in FIG. 12.

As illustrated in FIG. 12, the server 10 refers to the user database DB1, and acquires n-pieces (“n” is a natural number) of authenticated information (Step S200). In Step S200, the server 10 acquires n-pieces of authentication information stored in the records in which the date and time indicated by the date and time information is included in the latest predetermined period among the records in which the possession authentication flag is “1” or “2”. The server 10 may acquire all of the pieces of the authenticated information in which the date and time indicated by the date and time information is included in the latest predetermined period, or may acquire a predetermined number of pieces of the authenticated information.

The server 10 acquires n-outputs from the learning model M based on each of the n-pieces of authenticated information acquired in Step S200 (Step S201). In Step S201, the server 10 inputs each of the n-pieces of authenticated information into the learning model M one after another, and acquires the output corresponding to each piece of authenticated information. The server 10 calculates the ratio of the outputs indicating validity among the n-outputs acquired in Step S201 as the correct answer rate of the learning model M (Step S202).

The server 10 determines whether or not the correct answer rate of the learning model M is equal to or more than a threshold value (Step S203). When it is determined that the correct answer rate of the learning model M is equal to or more than the threshold value (“Y” in Step S203), the server 10 notifies the creator of the learning model M of an evaluation result indicating that the accuracy of the learning model M is high (“Y” in Step S204), and this process ends. The notification of the evaluation result may be performed by any method, for example, by electronic mail or a notification in the management program used by the creator. When the evaluation result of Step S204 is notified, this means that the accuracy of the learning model M is high, and therefore the creator of the learning model M does not create again the learning model M. In this case, fraud detection is executed by using the current learning model M.

When it is determined in Step S203 that the correct answer rate of the learning model M is less than the threshold value (“N” in Step S203), the server 10 notifies the creator of the learning model M of an evaluation result indicating that the accuracy of the learning model M is low (Step S205), and this process ends. In this case, the accuracy of the learning model M is low, and therefore the creator of the learning model M creates again the learning model M. The learning model M may be created again by the same method as in the first embodiment, or may be created again by another method. Until the new learning model M is created, the fraud detection is executed by using the current learning model M. When a new learning model M is created, the fraud detection is executed by using the new learning model M.

According to the second embodiment, the output from the learning model M is acquired based on the authenticated information, and the accuracy of the learning model M is evaluated based on the output corresponding to the authenticated information. Through focusing on the very high probability that authenticated users are valid, the accuracy of the learning model M can be accurately evaluated. For example, it may be difficult to manually determine whether an action of a user is valid or fraudulent. Further, even when the determination can be performed manually, such determination may take time. In this respect, the accuracy of the learning model M can be quickly evaluated by regarding authenticated users as being valid. It is possible to quickly detect that the accuracy of the learning model M has deteriorated and to quickly respond to the latest trend, and therefore fraudulent use in the service is prevented and security is increased. It is also possible to prevent a decrease in convenience, for example, a situation in which the action of the target user who is actually a valid user is estimated to be fraudulent and as a result the service is not usable by the user.

Further, the fraud detection system S can more accurately evaluate the accuracy of the learning model M by acquiring the output corresponding to each of the plurality of pieces of authenticated information, and evaluating the accuracy of the learning model M based on the output corresponding to each f the plurality of pieces of authenticated information. The fact that the accuracy of the learning model M has deteriorated can be detected more quickly. As a result of detecting the deterioration in the accuracy of the learning model M quickly, and as a result of the fact that the latest trend can be responded to quickly, it is possible to more reliably prevent fraudulent use of the service and to effectively increase security. Moreover, it is also possible to more reliably prevent a situation in which the action of the target user who is actually a valid user is estimated to be fraudulent and as a result the service is not usable by the user.

Further, the fraud detection system S can use the authenticated information on an authenticated user who has a very high probability of being valid to more accurately evaluate the accuracy of the learning model M by using the authenticated information on the user who has executed possession authentication to evaluate the learning model M. As a result of detecting the deterioration in the accuracy of the learning model M quickly, and as a result of the fact that the latest trend can be responded to quickly, it is possible to more reliably prevent fraudulent use of the service and to effectively increase security. Moreover, it is also possible to more reliably prevent a decrease in convenience, for example, a situation in which the action of the target user who is actually a valid user is estimated to be fraudulent and as a result the service is not usable by the user.

### [3. Modification Examples]

The present disclosure is not limited to the embodiments described above, and can be modified suitably without departing from the spirit of the present disclosure.

### [3-1. Modification Examples of First Embodiment]

First, modification examples of the first embodiment are described.

### [Modification Example 1-1]

For example, the fraud detection system S can be applied to any service. In Modification Example 1-1, a case in which the fraud detection system S is applied to an electronic payment service usable from the user terminal 20 is taken as an example. Similarly, the modification examples (Modification Example 1-2 to Modification Example 1-10) of the first embodiment other than Modification Example 1-1 and the modification examples (Modification Example 2-1 to Modification Example 2-9) of the second embodiment are also described by taking an electronic payment service as an example.

The electronic payment service is a service which executes electronic payment by using predetermined payment means. The user can use various payment means. For example, the payment means may be a credit card, a debit card, electronic money, electronic cash, points, a bank account, a wallet, or a virtual currency. Electronic payment using a code, such as a barcode or a two-dimensional code, is also sometimes referred to as “code payment,” and therefore the code may correspond to payment means.

In Modification Example 1-1, authentication is authentication of the electronic payment service executed from the user terminal 20. The authenticated information is information relating to an action of an authenticated user in the electronic payment service. The learning model M is a model for detecting fraud in the electronic payment service. The electronic payment service is hereinafter simply referred to as “service.”

The fraud detection system S of Modification Example 1-1 provides a service using a card of the user. A credit card is taken as an example of the card. The card may be any card that can be used for electronic payment, and is not limited to a credit card. For example, the card may be a debit card, a loyalty card, an electronic money card, a cash card, a transportation card, or any other card. The card is not limited to an IC card, and may be a card that does not include an IC chip. For example, the card may be a magnetic card.

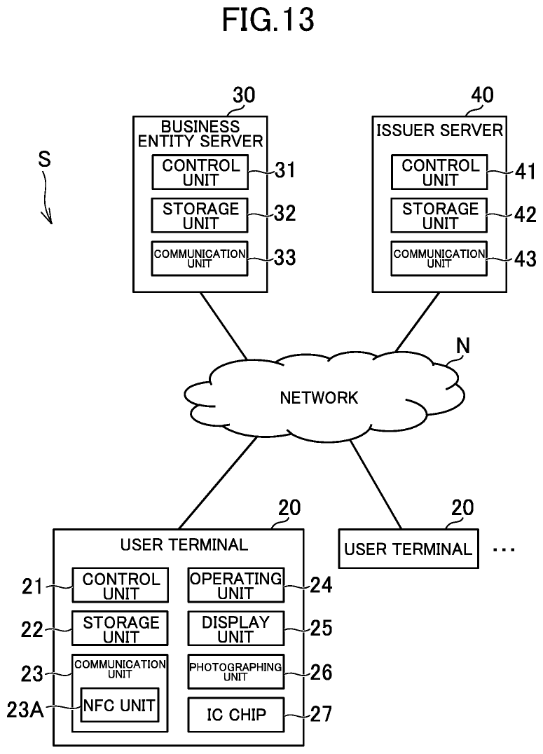

FIG. 13 is a diagram for illustrating an example of an overall configuration of the fraud detection system S of Modification Example 1-1. The fraud detection system S may have the same overall configuration as that of FIG. 1, but in Modification Example 1-1, an example of another overall configuration is described. As illustrated in FIG. 13, the fraud detection system S of the modification examples includes a user terminal 20, a business entity server 30, and an issuer server 40. It is sufficient that the fraud detection system S includes at least one computer, and is not limited to the example of FIG. 13. Each of the user terminal 20, the business entity server 30, and the issuer server 40 is connected to the network N. The user terminal 20 is the same as in the first embodiment and the second embodiment.

The business entity server 30 is a server computer of a business entity providing a service. The business entity server 30 includes a control unit 31, a storage unit 32, and a communication unit 33. Physical configurations of the control unit 31, the storage unit 32, and the communication unit 33 are the same as those of the control unit 11, the storage unit 12, and the communication unit 13, respectively.

The issuer server 40 is a server computer of an issuer which has issued the credit card. The issuer may be the same as the business entity, but in Modification Example 1-1, a case in which the issuer is different from the business entity is described. The issuer and the business entity may be group companies that can cooperate with each other. The issuer server 40 includes a control unit 41, a storage unit 42, and a communication unit 43. Physical configurations of the control unit 41, the storage unit 42, and the communication unit 43 are the same as those of the control unit 11, the storage unit 12, and the communication unit 13, respectively.

At least one of programs or data stored in the storage units 32 and 42 may be supplied thereto via the network N. Further, at least one of the business entity server 30 or the issuer server 40 may include at least one of a reading unit (e.g., an optical disc drive or a memory card slot) for reading a computer-readable information storage medium, or an input/output unit (e.g., a USB port) for inputting and outputting data to/from an external device. For example, at least one of the program or the data stored in the information storage medium may be supplied through intermediation of at least one of the reading unit or the input/output unit.

In Modification Example 1-1, an application for electronic payment (hereinafter referred to simply as “app”) is installed on the user terminal 20. The user has completed use registration in advance, and can log in to the service by using a user ID and a password. The user can use any payment means from the app. In Modification Example 1-1, a case in which the user uses a credit card and electronic cash from the app is taken as an example. The credit card is hereinafter simply referred to as “card.”

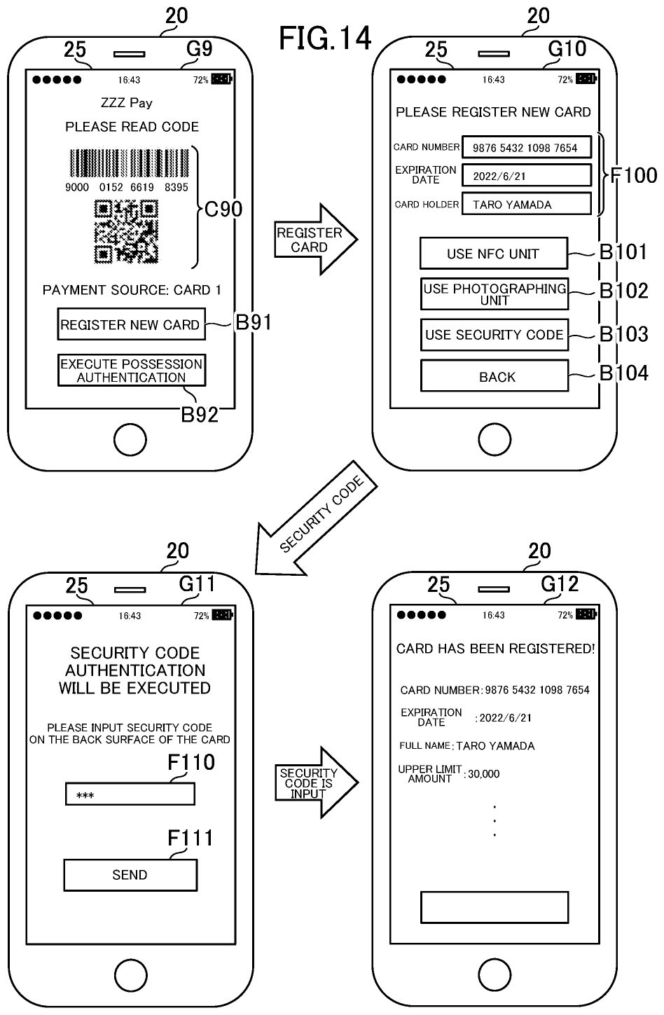

FIG. 14 is a view for illustrating an example of screens displayed on the user terminal 20 in Modification Example 1-1. As illustrated in FIG. 14, when the user operates the user terminal 20 to start the app, a top screen G9 of the app is displayed on the display unit 25. A code C90 for electronic payment is displayed on the top screen G9. For example, when the code C90 is read by a POS terminal or a code reader of a shop, payment processing is executed based on the payment means of a payment source set in advance. A known method can be used for the payment processing itself using the code C90.

In the example of FIG. 14, a card registered under the name “card 1” is set as the payment source. When the code C90 is read in this state, payment processing using this card is executed. The user can also use the card set as the payment source to add electronic cash usable in the app. Electronic cash is online electronic money. When the user changes the payment source to electronic cash and the code C90 is read, payment processing using the electronic cash is executed.

In Modification Example 1-1, a new card can be registered from the top screen G9. For example, when the user selects a button B91, a registration screen G10 for registering a new card is displayed on the display unit 25. The user inputs card information, for example, the card number, expiration date, and card holder, from an input form F100. In Modification Example 1-1, a plurality of authentication methods, for example, NFC authentication, image authentication, and security code authentication, can be used as the authentication at the time of card registration. The user can select buttons B101 to B103 and select any of the authentication methods. The authentication at the time of credit card registration may be another authentication method. For example, an authentication method called “3D Secure” may be used.

NFC authentication is the same as in the first embodiment and the second embodiment, and is executed by reading the card by using the NFC unit 23A. Image authentication is also the same as in the first embodiment and the second embodiment, and is executed by photographing the card by the photographing unit 26. Security code authentication is executed by inputting a security code formed on the back surface of the card from the operating unit 24. As a general rule, the security code is information that is known only when the card is possessed. Thus, in Modification Example 1-1, not only NFC authentication and image authentication but also security code authentication is described as an example of possession authentication.

In FIG. 14, the flow of security code authentication is illustrated. For example, when the user selects the button B103, an authentication screen G11 for executing security code authentication is displayed on the display unit 25. When the user inputs the security code in an input form F110 and selects a button B111, the user terminal 20 transmits the card information input in the input form F100 and the security code input in the input form F110 to the business entity server 30. The card information and the security code are hereinafter referred to as “input card information” and “input security code,” respectively.

The business entity server 30 receives the input card information and the input security code from the user terminal 20, transfers the input card information and the input security code to the issuer server 40, and the issuer server 40 executes security code authentication. The card information and the security code registered in advance in the issuer server 40 are hereinafter referred as “registered card information” and “registered security code,” respectively. Security code authentication is successful when the same combination of registered card information and registration security code as the combination of input card information and input security code exists in the issuer server 40.

When security code authentication is executed, the registration of the card for which the input card information is input from the input form F100 is complete. On the user terminal 20, a completion screen G12 indicating that the card registration is complete is displayed on the display unit 25. The user can then set the registered card as the payment source.

In Modification Example 1-1, an upper limit amount that is usable from the app is set for each card. The upper limit amount may mean the upper limit amount of the card itself (so-called usage limit or limit amount), but in Modification Example 1-1, the upper limit amount is not the upper limit amount of the card itself, but is the upper limit amount in the app. For example, the upper limit amount is the total amount that is usable from the app in a predetermined period (for example, one week or one month). The upper limit amount may be the upper limit amount per payment process.

The upper limit amount of the card depends on the authentication method of possession authentication executed at the registration of the card. As the security of the possession authentication executed at the time of card registration becomes higher, the upper limit amount of the card becomes higher. For example, the security code may be leaked due to phishing, and therefore security code authentication has the lowest security. Meanwhile, NFC authentication or image authentication is in principle not successful without possession of the physical card, and therefore has security higher than that of security code authentication.

In the example of FIG. 14, security code authentication, which has the lowest security, is executed, and therefore the upper limit amount is the lowest, namely, 30,000 yen. For example, when the user selects the button B101 or the button B102 at the time of card registration and executes NFC authentication or image authentication, the upper limit amount becomes 100,000 yen, which is higher than 30,000 yen. After registering the card, the user can also increase the upper limit amount by executing possession authentication, which is a highly secure authentication method.

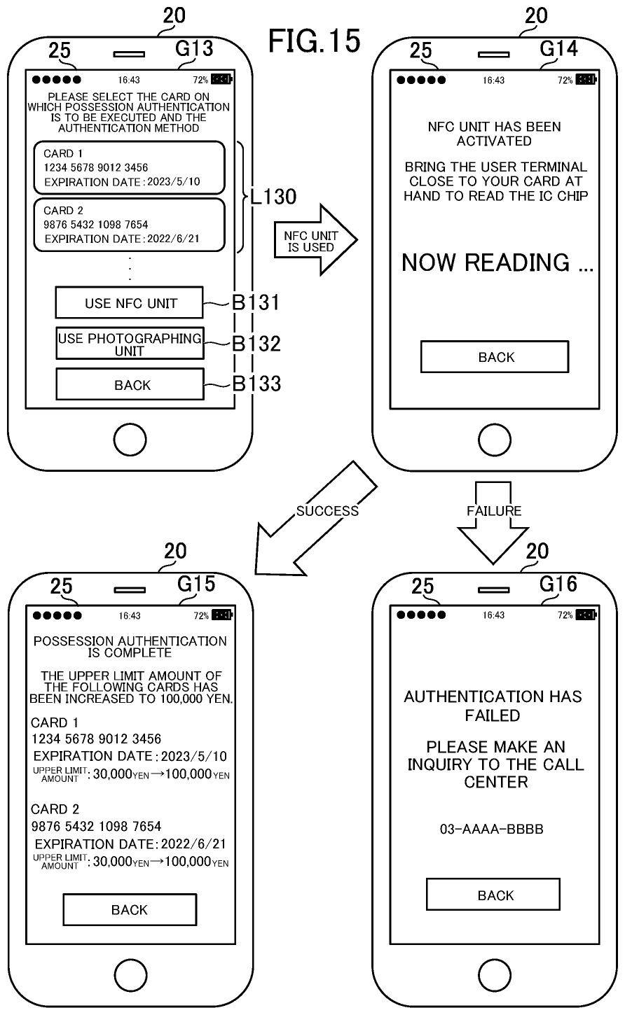

FIG. 15 is a view for illustrating an example of a flow for increasing the upper limit amount after the registration of the card. When a button B92 of the top screen G9 of FIG. 14 is selected, as illustrated in FIG. 15, a selection screen G13 for selecting the card on which possession authentication is to be executed displayed on the display unit 25. A list L130 of registered cards is displayed on the selection screen G13. The user selects the card on which possession authentication is to be executed from the list L130.

The user can select any authentication method. For example, when the user selects a card on which security code authentication has been executed, the user can select NFC authentication or image authentication, which have higher security than that of security code authentication. When the user selects a button B131, a reading screen G14 similar to the reading screen G6 is displayed on the display unit 25. When the reading screen G14 is displayed, the user brings the user terminal 20 closer to the card possessed by the user.

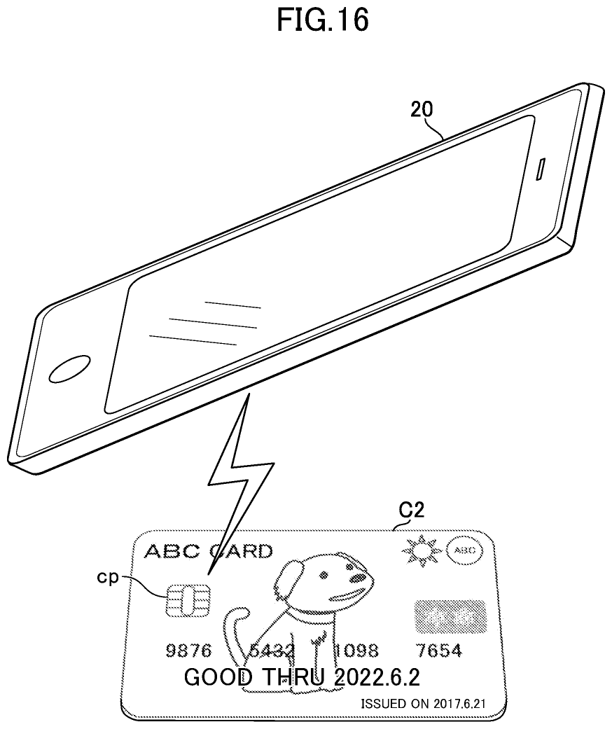

FIG. 16 is a view for illustrating an example of how the NFC unit 23A reads the IC chip of the card. In FIG. 16, a card C2 having an electronic money function is taken as an example. The electronic money of the card C2 may be usable from the app, but in Modification Example 1-1, the electronic money of the card C2 is not usable from the app. That is, the electronic money of the card C2 is different from the electronic cash that is usable from the app. The electronic money of the card C2 is used for possession authentication. That is, in Modification Example 1-1, possession authentication is executed by using electronic money in another service that is not directly related to the service provided by the app.

An electronic money ID that can identify the electronic money is recorded on the IC chip cp. As illustrated in FIG. 16, when the user brings the user terminal 20 closer to the IC chip cp of the card C2, the NFC unit 23A reads the information recorded on the IC chip cp. The NFC unit 23A can read any information in the IC chip cp. In Modification Example 1-1, a case in which the NFC unit 23A reads an electronic money ID recorded on the IC chip cp is described.

The user terminal 20 transmits the electronic money ID read from the IC chip cp to the business entity server 30. The electronic money ID is input from the user terminal 20 to the business entity server 30, and is hence hereinafter referred to as “electronic money ID.” In the issuer server 40, the electronic money ID to be used as a correct answer is registered. This electronic money ID is hereinafter referred to as “registered electronic money ID.” In the following description, the input electronic money ID and the registered electronic money ID may be referred to simply as “electronic money ID” unless particularly distinguished therebetween.

The business entity server 30 transfers the input electronic money ID received from the user terminal 20 to the issuer server 40. At that time, it is assumed that the input card information on the card C2 selected by the user from the list L130 is also transmitted. When the user is the valid owner of the card C2, the same combination of registered card information and registered electronic money ID as the combination of input card information and input electronic money ID is registered in the issuer server 40.

When the same combination of registered card information and registered electronic money ID as the combination of input card information and input electronic money ID is registered in the issuer server 40, possession authentication is successful. In this case, a success screen G15 indicating that the possession authentication is successful is displayed on the display unit 25. When NFC authentication is executed as illustrated on the success screen G15, the upper limit amount of the card C2 (“card 2” in the example of FIG. 15) increases from 30,000 yen to 100,000 yen.

In Modification Example 1-1, the upper limit amount of another card (“card 1” in the example of FIG. 15) different from the card C2 on which NFC authentication is executed also increases from 30,000 yen to 100,000 yen, but it is not required that the upper limit amount of the another card increase. Even in a case in which the another card is associated with the same user ID as the card C2 on which NFC authentication is executed, when the card holder is different, the upper limit amount is not increased because there is a possibility that a third party registered the card without permission. When the same combination of registered card information and registered electronic money ID as the combination of input card information and input electronic money ID is not registered in the issuer server 40, possession authentication fails. In this case, a failure screen G16 similar to the failure screen G8 of FIG. 3 is displayed on the display unit 25.

Image authentication is also executed based on a similar flow. In NFC authentication, the input electronic money ID is acquired by using the NFC unit 23A, whereas in image authentication, the input electronic money ID is acquired by using a photographed image obtained by photographing the card C2. For example, when the user selects a button B132 of the selection screen G13, the photographing unit 26 is activated. The photographing unit 26 photographs the card C2. In the example of the card C2 of FIG. 16, it is assumed that the input electronic money ID is formed on the back surface, but the input electronic money ID may be formed on the front surface.

When the user photographs the back surface of the card C2, the user terminal 20 transmits the photographed image to the business entity server 30. The business entity server 30 receives the photographed image, and acquires the input card information by executing optical character recognition on the photographed image. The flow after the input card information is acquired is the same as for NFC authentication. The optical character recognition may be executed on the user terminal 20. Similarly to the input individual number in the first embodiment, the input electronic money ID may be included in a code, such as a bar code or a two-dimensional code.

The information used in possession authentication is not limited to the input electronic money ID. For example, when the card C2 also has the function of a loyalty card, a loyalty card ID that can identify the points on the card may be used in possession authentication. It is assumed that the loyalty card ID is included in the card C2. Further, for example, the card number or expiration date of the card C2 may be used in the possession authentication. In Modification Example 1-1, it is sufficient that some sort of information contained in the card C2 or information associated with this information is used in the possession authentication, and the design or issue date, for example, of the card C2 may also be used in the possession authentication.

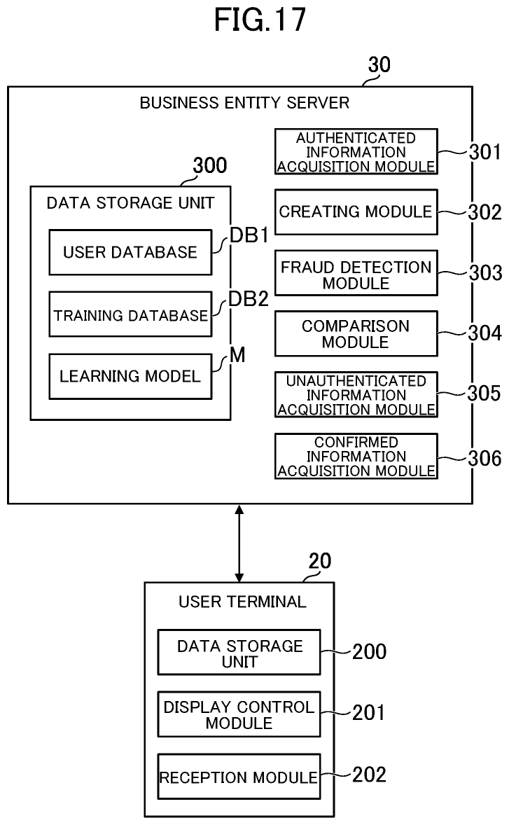

FIG. 17 is a functional block diagram in the modification examples of the first embodiment. In FIG. 17, the functions in Modification Example 1-2 to Modification Example 1-10 described after Modification Example 1-1 are also illustrated. As illustrated in FIG. 17, here, a case in which the main functions are implemented by the business entity server 30 is described. A data storage unit 300, an authenticated information acquisition module 301, a creating module 302, a fraud detection module 303, a comparison module 304, an unauthenticated information acquisition module 305, and a confirmed information acquisition module 306 are implemented on the business entity server 30. The data storage unit 300 is implemented mainly by the storage unit 32. The other functions are implemented mainly by the control unit 31.

The data storage unit 300 stores a user database DB1, a training database DB2, and a learning model M in the data storage unit 300. Those pieces of data are substantially the same as in the first embodiment, but the specific content of the user database DB1 is different from that in the first embodiment.

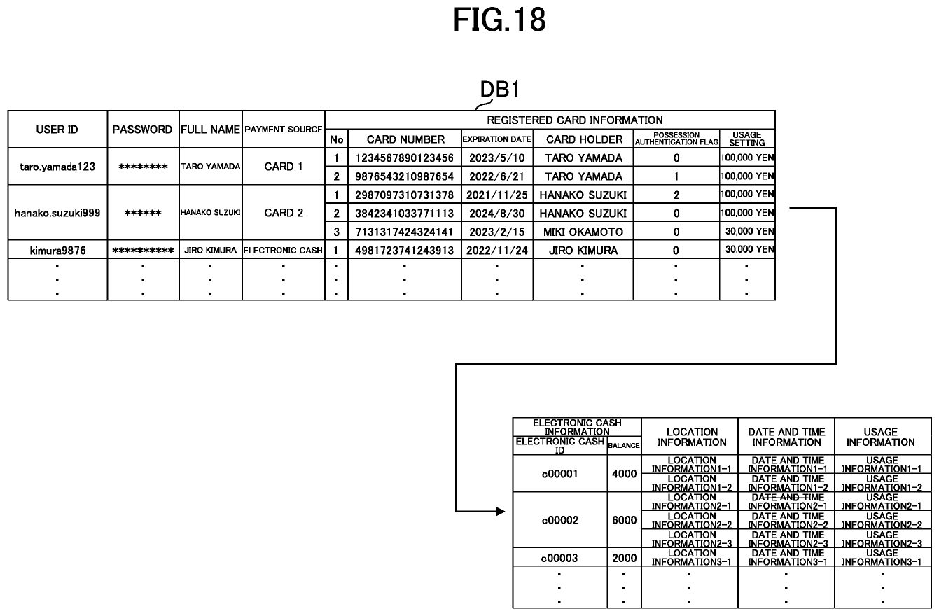

FIG. 18 is a table for showing a data storage example of the user database DB1. As shown in FIG. 18, the user database DB1 is a database in which information relating to users who have completed use registration is stored. For example, the user database DB1 stores a user ID, a password, a full name, payment means of a payment source, registered card information, electronic cash information, location information, date and time information, and usage information. For example, when the user has performed use registration, a user ID is issued and a new record is created in the user database DB1. In this record, the registered card information and the electronic cash information are stored together with the password and full name designated at the time of use registration.

The registered card information is information relating to the card C2 registered by the user. For example, the registered card information includes a serial number for identifying a card from among cards of each of the users, a card number, an expiration date, a card holder, a possession authentication flag, and a usage setting. As described above, the usage setting in Modification Example 1-1 is the setting of the upper limit amount of the card C2 that is usable from the app. When the user registers a new card C2, registered card information corresponding to the card C2 is added.

The electronic cash information is information relating to the electronic cash that is usable from the app. For example, the electronic cash information includes an electronic cash ID that can identify the electronic cash and a remaining amount of the electronic cash. Electronic cash can be added to the card C2 registered by the user. The setting of the upper limit amount that can be added in this case may correspond to the usage setting. The information stored in the user database DB1 is not limited to the example of FIG. 18.

The point that the combination of the location information, date and time information, and usage information corresponds to the authenticated information is the same as in the first embodiment. In the modification examples, the location information indicates a location at which payment processing is executed. This location is a location at which, for example, a shop or a vending machine is located. The date and time information is a date and time at which payment processing is executed. The usage information is information on, for example, the usage amount, the purchased product, and the payment means used (payment means of the payment source set at the time of executing payment processing). In the data storage example of FIG. 18, location information, date and time information, and usage information are stored for each combination of the user ID and the terminal ID, but location information, date and time information, and usage information may be stored for each user ID and each card C2.

The authenticated information acquisition module 301, the creating module 302, and the fraud detection module 303 are the same as the authenticated information acquisition 5 module 101, the creating module 102, and the fraud detection module 103, respectively. The learning model M in Modification Example 1-1 is a model for detecting fraudulent payment processing. The creating module 302 creates the learning model M such that information indicating that the payment processing is valid is output when location information on a shop, for example, at which an authenticated user executed payment processing, date and time information on when the payment processing is executed, and usage information on the payment amount, for example, are input.

The fraud detection module 103 acquires the output from the learning model M based on the location information on a shop, for example, at which a target user executed payment processing, date and time information on when the payment processing is executed, and usage information on the payment amount, for example, and detects fraud by determining whether or not the output indicates fraud. For example, fraud in Modification Example 1-1 is the act in which payment means is used based on a fraudulent login by a third party, an act in which a card number fraudulently obtained by a third party is registered in his or her own user ID and payment processing in the shop is executed, or an act in which a third party adds electronic money or electronic cash by using a card number that he or she fraudulently obtained. An act in which a third party fraudulently logs in and changes the payment source, an act in which a third party registers registered card information without permission, or an act in which a third party changes another setting or registered information is equivalent to fraud.

According to Modification Example 1-1, it is possible to simplify the creation of a learning model M for detecting fraud in payment.

### [Modification Example 1-2]

For example, in a service like that in Modification Example 1-1, it is possible for an authenticated user to use each of a first card C2, which is the predetermined card C2, and a second card C3. In Modification Example 1-2, a case in which the first card C2 is the card on which possession authentication is executed is described, but the authentication method for the first card C2 is not limited to possession authentication. The authentication method for the first card C2 may be any authentication method, and may be, for example, knowledge authentication or biometric authentication. 3D Secure is an example of knowledge authentication. Examples of other authentication methods are as described in the first embodiment. The first card C2 may be any card as long as the card is a card on which the above-mentioned predetermined authentication is executed.

In Modification Example 1-2, the reference symbol C3 is added to the second card in order to distinguish the second card from the first card C2, but the second card C3 is not shown in the drawings. The second card C3 associated with the first card C2 is a second card C3 associated with the same user ID as the first card C2. The first card C2 and the second card C3 may be directly associated with each other, instead of via the user ID.

The second card C3 is a card on which possession authentication has not been executed. The second card C3 may be a card on which possession authentication can be executed, but has not been executed yet. When the second card C3 is a card on which possession authentication can be executed, the second card C3 may correspond to the first card C2. In Modification Example 1-2, the second card C3 is a card that does not support NFC authentication or image authentication. For example, the second card C3 does not include the input electronic money ID used in NFC authentication or image authentication.

For example, even when the second card C3 includes an IC chip, the IC chip does not include the input electronic money ID. Even when some sort of electronic money ID is included in the IC chip, the electronic money ID is an electronic money ID of other electronic money that is not used in NFC authentication or image authentication. Similarly, even when some sort of electronic money ID is formed on the second card C3, the electronic money ID is an electronic money ID of other electronic money that is not used in NFC authentication or image authentication.

The authenticated information acquisition module 101 acquires the authenticated information corresponding to the first card C2. The acquired authenticated information is the authenticated information on the first card C2 having the possession authentication flag of “1” or “2”. The authenticated information acquisition module 101 refers to the user database DB1, identifies a record in which the payment means indicated by the usage information is the first card C2 and in which the possession authentication flag is “1” or “2”, and acquires the location information, date and time information, and usage information stored in the identified record as the authenticated information.

The creating module 302 creates the learning model M based on the authenticated information corresponding to the first card C2. The creating module 302 is not required to use the location information, the date and time information, and the usage information corresponding to the second card C3 in the creation of the learning model M. The method itself of creating the learning model M based on the authenticated information is as described in the first embodiment.

According to Modification Example 1-2, the learning model M is created based on the authenticated information corresponding to the first card C2. Through focusing on the authenticated information corresponding to the first card C2 having a very high probability of being valid, it is possible to effectively achieve the simplified creation of the learning model M, quick creation of the learning model M, prevention of fraudulent use in the service, improved security, and prevention of a deterioration in convenience described in the first embodiment.

### [Modification Example 1-3]

For example, even in a case in which possession authentication of the second card C3 is not executed, when the card holder is the same as that of the first card C2 on which the possession authentication has been executed, there is a very high probability that the action using the second card C3 is also valid. Thus, on condition that the card holder is the same, the location information, the date and time information, and the usage information on the second card C3 may be used as the authenticated information.

The fraud detection system S comparison module 304 which compares first name information relating to a name of the first card C2 and second name information relating to a name of the second card C3. The further includes the first name information is information relating to the name of the first card C2. The second name information is information relating to the name of the second card C3. In Modification Example 1-3, a case in which the first name information indicates a first card holder, which is the card holder of the first card C2, and the second name information indicates a second card holder, which is the card holder of the second card C3, is described.

The first card holder is a character string indicating the name of the card holder of the first card C2. The second card holder is a character string indicating the name of the card holder of the second card C3. The character string of the card holder can be represented in any language. Further, each of the first name information and the second name information may be information other than information on the card holder. For example, each of the first name information and the second name information may be the address, telephone number, date of birth, gender, or electronic mail address of the card holder, a combination thereof, or other personal information.

In Modification Example 1-3, a case in which the comparison module 304 is implemented by the business entity server 30 is described, but the comparison module 304 may be implemented by the issuer server 40. For example, when information not stored in the user database DB1 is used as the first name information and the second name information, the comparison between the first name information and the second name information may be executed by the issuer server 40. The comparison as used herein is determination of whether or not the first name information and the second name information match.

In Modification Example 1-3, the data storage unit 300 stores a database in which information relating to various cards is stored. The name information on the various cards is stored in the database. The first name information and the second name information are acquired from the database. When the business entity server 30 does not manage this database, it suffices that the business entity server 30 requests the issuer server 40 to compare the first name information and the second name information, and acquires only a result of the comparison from the issuer server 40. For example, the comparison module 304 compares the first card holder and the second card holder. The comparison module 304 refers to the user database DB1, acquires the first card holder and the second card holder, and transmits a result of comparison therebetween to the authenticated information acquisition module 101. As described above, the first name information and the second name information may be other information.

The authenticated information acquisition module 101 acquires the authenticated information corresponding to the second card C3 when the comparison result obtained by the comparison module 304 is a predetermined result. In Modification Example 1-3, a case in which the matching of the first card holder and the second card holder corresponds to the predetermined result is described, but a matching with the other information described above may correspond to the predetermined result. When a plurality of pieces of information are included in each of the first name information and the second name information, a match of a predetermined number or more of pieces of the information may correspond to the predetermined result. For example, when each of the first name information and the second name information includes four pieces of information, for example, the card holder, address, telephone number, and date of birth, the predetermined result may be that two or more pieces of the information match. As used herein, match may refer to a partial match instead of an exact match.

In the example of FIG. 18, the first card holder of the first card C2 (No. 2 card) having the user ID “taro.yamada123” and the second card holder of the second card C3 (No. 1 card) are both “TARO YAMADA.” Thus, when the possession authentication of the first card C2 is executed, the second card C3 is also used in the learning of the learning model M.

Meanwhile, the first card holder of the first card C2 (No. 1 card) having the user ID “hanako.suzuki999” and a second card holder of a certain second card C3 (No. 2 card) are both “HANAKO SUZUKI.” Thus, when the possession authentication of the first card C2 is executed, the certain second card C3 is also used in the learning of the learning model M. However, the second card holder of the other second card C3 (No. 3 card) is “MIKI OKAMOTO,” which is different from the first card holder. Thus, there is a possibility that the other second card C3 has been registered by a third party without permission, and the action using the other second card C3 may not be valid, and is therefore not used in the learning of the learning model M.

The creating module 302 creates the learning model M based on the authenticated information corresponding to the first card C2 and the authenticated information corresponding to the second card C3 when the comparison result obtained by the comparison module 304 is the predetermined result. Possession authentication has not been executed on the second card C3, and therefore although the location information, date and time information, and usage information on the second card C3 do not strictly correspond to authenticated information, those pieces of information are treated as being equivalent to the authenticated information corresponding to the first card C2, and therefore are described here as authenticated information corresponding to the second card C3. The only difference from the first embodiment and Modification Example 1-1 is that the authenticated information corresponding to the second card C3 is used in the learning. The learning method itself of the learning model M is the same as in the first embodiment and Modification Example 1-1. The creating module 302 creates the learning model M such that when the authenticated information corresponding to the first card C2 and the authenticated information corresponding to the second card C3 are each input to the learning model M, those pieces of information are estimated to be valid.

According to Modification Example 1-3, by creating the learning model M based on the authenticated information corresponding to the first card C2 and the authenticated information corresponding to the second card C3 when a comparison result between the first name information relating to the name of the first card C2 and the second name information relating to name of the second card C3 is a predetermined result, more authenticated information is learned and the accuracy of the learning model M is more increased. As a result, it is possible to effectively achieve prevention of fraudulent use in the service, improvement of security, and prevention of deterioration of convenience.

### [Modification Example 1-4]

For example, the second card C3 described in Modification Example 1-3 may be a card that does not support possession authentication. The authenticated information corresponding to the second card C3 may be information relating to the action of an authenticated user who has used the second card C3 on which possession authentication has not been executed. A card that does not support possession authentication is a card that is not capable of executing possession authentication. For example, a card that does not include an IC chip does not support NFC authentication. For example, a card on which an input electronic money ID is not formed on the face of the card does not support image authentication. For example, a card that does not include an input electronic money ID used in possession authentication is a card that does not support possession authentication.

According to Modification Example 1-4, even when the second card C3 is a card that does not support possession authentication, by creating the learning model M based on the authenticated information corresponding to the second card C3, the accuracy of the learning model M is further increased.

### [Modification Example 1-5]

For example, the learning model M may perform learning by using the action of an unauthenticated user who has not executed possession authentication. The fraud detection system S further includes the unauthenticated information acquisition module which 305 acquires unauthenticated information relating to the action of an unauthenticated user who has not executed authentication. An unauthenticated user is a user having a possession authentication flag which is not “1” or “2”. That is, an unauthenticated user is a user having a possession authentication flag which is at least partly “0”. The unauthenticated information acquisition module 305 refers to the user database DB1, and acquires the unauthenticated information on the unauthenticated user. The unauthenticated information is a combination of the location information, date and time information, and usage information on the unauthenticated user. The point that the unauthenticated information may be any information and is not limited to a combination of the location information, date and time information, and usage information is the same as described regarding the authenticated information.

The creating module 302 creates training data indicating that the action of the unauthenticated user is valid or fraudulent based on the unauthenticated information, and trains the learning model M based on the created training data. The training data created by using the authenticated user is hereinafter referred to as “first training data,” and the training data created by using the unauthenticated user is hereinafter referred to as “second training data.” The data structures themselves of the first training data and the second training data are the same, and are as described in the first embodiment.

In principle, the output portion of the first training data always indicates valid, whereas the output portion of the second training data does not always indicate valid. For example, the output portion of the second training data is designated by the creator of the learning model M, For an unauthenticated user for which fraud has been determined by the creator of the learning model M, the output portion of the second training data indicates fraud. The data structures of the first training data and the second training data are the same, and therefore the method of creating the learning model M based on each of the first training data and the second training data is as described in the first embodiment.

According to Modification Example 1-5, by creating second training data indicating that the action of the unauthenticated user is valid or fraudulent based on the unauthenticated information, and training the learning model M based on the second training data, the accuracy of the learning model M is further increased by using more information.

### [Modification Example 1-6]

For example, in Modification Example 1-5, the creating module 302 may acquire the output from the trained learning model M based on the unauthenticated information, and create the second training data based on the output. For example, the creating module 302 presents the output of the learning model M corresponding to the unauthenticated information to the creator of the learning model M. The creator of the learning model M checks whether or not the output is correct. The creator modifies the output as required.

For example, when an unauthenticated user is thought to be actually valid, but the output from the learning model M indicates fraud, the creator modifies the output to valid. Conversely, when an unauthenticated user is thought to be actually fraud, but the output from the learning model M indicates valid, the creator modifies the output to fraud. The creating module 302 creates the second training data based on the modification result of the unauthenticated user. When the output for the unauthenticated user is not modified, the creating module 302 creates the second training data based on the output from the learning model M. The method itself of creating the learning model M by using the second training data is as described in Modification Example 1-5.

According to Modification Example 1-6, by acquiring the output from the trained learning model M based on the unauthenticated information and creating the second training data based on the output, the accuracy of the learning model M is further increased by using more information.

### [Modification Example 1-7]

For example, in Modification Example 1-5, it may gradually become clear whether a certain unauthenticated user is a fraudulent user or a valid user while the unauthenticated user continues to use the service. Thus, the creating module 302 may change, based on unauthenticated information after an output corresponding to the unauthenticated information is acquired, the content of the output and create the second training data based on the changed output content.

The learning model M in Modification Example 1-7 outputs a score relating to fraud in the service. In Modification Example 1-7, a case in which the score indicates a validity degree is described, but the score may indicate a fraud degree. When the score indicates a validity degree, the score indicates a likelihood of an action being classified as valid. When the score indicates a fraud degree, the score indicates a likelihood of an action being classified as fraud. As the method itself of calculating the score by the learning model M, various known methods can be used. The creating module 302 acquires the score from the learning model M based on the unauthenticated action of the unauthenticated user. The creating module 302 changes the score based on subsequent actions of the unauthenticated user. The method of changing the score is defined in advance in the data storage unit 100. For example, a relationship between an action classified as fraud and the amount of change in the score when the action is performed (in this modification example, the amount of decrease because the score indicates the validity degree) is defined. Similarly, a relationship between action classified as valid and the amount of change in the score when the action is performed (in this modification example, the amount of increase because the score indicates the validity degree) is defined. The creating module 302 changes the score based on the amount of change corresponding to an action suspected of being fraud such that when an unauthenticated user performs the action, the fraud degree increases. The creating module 302 changes the score based on the amount of change corresponding to an action suspected to be valid such that the fraud degree decreases when the unauthenticated user performs the action.

When the learning model M does not output a score, and instead outputs a classification result of whether or not the action is fraudulent, the creating module 302 may change the classification result. For example, when it is assumed that the output of the learning model M is “1” indicating fraud or “0” indicating valid, in a case in which the output corresponding to the unauthenticated information is “1” and the unauthenticated user is classified as being a fraudulent user, the creating module 302 may create the second training data by changing the output to “0” when the unauthenticated user later continuously performs actions having high probability of being valid. In a case in which the output corresponding to the unauthenticated information is “0” and the unauthenticated user is classified as being a valid user, the creating module 302 may create the second training data by changing the output to “1” when the unauthenticated user later continuously performs actions having high probability of being fraud.

According to Modification Example 1-7, the accuracy of the learning model M is further increased by changing the content of the output based on the unauthenticated information after the output t corresponding to the unauthenticated information is acquired, and creating the second training data based on the changed output content.

### [Modification Example 1-8]

For example, in Modification Example 1-7, an upper limit value may be set to the score corresponding to the unauthenticated information such that the score corresponding to the unauthenticated information indicates fraud more than the score corresponding to the authenticated information. The creating module 302 determines the upper limit value of the score corresponding to the unauthenticated information based on the score of the authenticated information output from the learning model M. For example, the creating module 302 determines an average value of the scores of the authenticated information as the upper limit value of the score corresponding to the unauthenticated information. Further, for example, the creating module 302 determines the lowest value or a predetermined lowest value among the scores of the authenticated information as the upper limit value of the score corresponding to the unauthenticated information.

The learning model M outputs the score corresponding to the unauthenticated information based on the upper limit value. The learning model M outputs the score corresponding to the unauthenticated information such that the upper limit value is not exceeded. For example, even when the score calculated internally in the learning model M exceeds the upper limit value, the learning model M outputs the score such that the output score is equal to or less than the upper limit value. The upper limit value may be an average value, for example, of scores obtained by inputting unauthenticated information into the learning model M. The method itself of creating the learning model M by using the score corresponding to the unauthenticated information is as described in Modification Example 1-7.

According to Modification Example 1-8, the accuracy of the learning model M is further increased by outputting a score corresponding to the unauthenticated information based on an upper limit value set to indicate fraud more than the score corresponding to the authenticated information.

### [Modification Example 1-9]

For example, the learning model M may be created by also using an action of a confirmed user for which the action has been confirmed as being fraudulent or not fraudulent after a predetermined time has passed. The fraud detection system S further includes the confirmed information acquisition module 306 which acquires confirmed information relating to the action of the confirmed user for which the action has been confirmed as being fraudulent or not fraudulent. The confirmed information differs from the authenticated information in that the confirmed information is information on the action of the confirmed user, but the data structure itself is similar to that of the authenticated information. Thus, the confirmed information includes the location information, the date and time information, and the usage information on the confirmed user stored in the user database DB1. The confirmed information is the same as the authenticated information in that the content included in the confirmed information is not limited to those pieces of information. Whether or not the action is fraudulent may be designated by the creator of the learning model M, or may be determined based on a predetermined rule.

The creating module 302 creates the learning model M based on the authenticated information and the confirmed information. The only difference from the first embodiment and the other modification examples is that the confirmed information is used, and the method itself of creating the learning model M is the same as that of the first embodiment and the other modification examples. That is, the creating module 302 creates the learning model M such that a result indicating valid is output when the authenticated information is input and a result associated with the confirmed information (result relating to whether the action is fraudulent or valid) is output when each piece of confirmed information is input.

According to Modification Example 1-9, by creating the learning model M based on the authenticated information and the confirmed information on the confirmed user, more information is used for learning, and the accuracy of the learning model M is further increased.

### [Modification Example 1-10]

For example, the learning model M may be an unsupervised learning model. The creating module 302 creates the learning model M based on the authenticated information such that a fraud action in the service is an outlier. For example, the creating module 302 creates an unsupervised learning model M such that when each of a plurality of pieces of authenticated information is input, those pieces of authenticated information are clustered into the same cluster. In this learning model M, when information on a fraud action which is different from the feature indicated by the authenticated information is input, the fraud action is output as an outlier. That is, the fraud action is output as an action that does not belong to the cluster of authenticated information. Various methods can be used for the unsupervised learning itself. For example, in addition to the above-mentioned clustering method, principal component analysis, vector quantization, non-negative matrix factorization, a k-means method, and a mixed Gaussian model can be used. The fraud detection module 303 acquires the output of the learning model M based on the target information on the target user, and when the output is an outlier, determines that the action is fraudulent. The fraud detection module 303 determines that the output is valid when the action is not an outlier.

According to Modification Example 1-10, creation of the learning model M which uses unsupervised learning can be simplified by creating, based on the authenticated information, a learning model M which uses unsupervised learning such that a fraud action in the service becomes an outlier. Further, a series of processes of the creation of the learning model M can be automated, and the learning model M can be created quickly. A learning model M which has learned the latest trend can be quickly applied to the fraud detection system S, and fraud can be accurately detected. As a result, fraudulent use in the service is prevented and security is increased. Moreover, it is also possible to prevent a decrease in convenience, for example, a situation in which the action of the target user who is actually a valid user is estimated to be fraudulent and as a result the service is not usable by the user.

### [3-2. Modification Examples of Second Embodiment]

Next, modification examples of the second embodiment are described.

### [Modification Example 2-1]

For example, the fraud detection system S of the second embodiment can also be applied to the electronic payment service as described in Modification Example 1-1 to Modification Example 1-10 of the first embodiment.

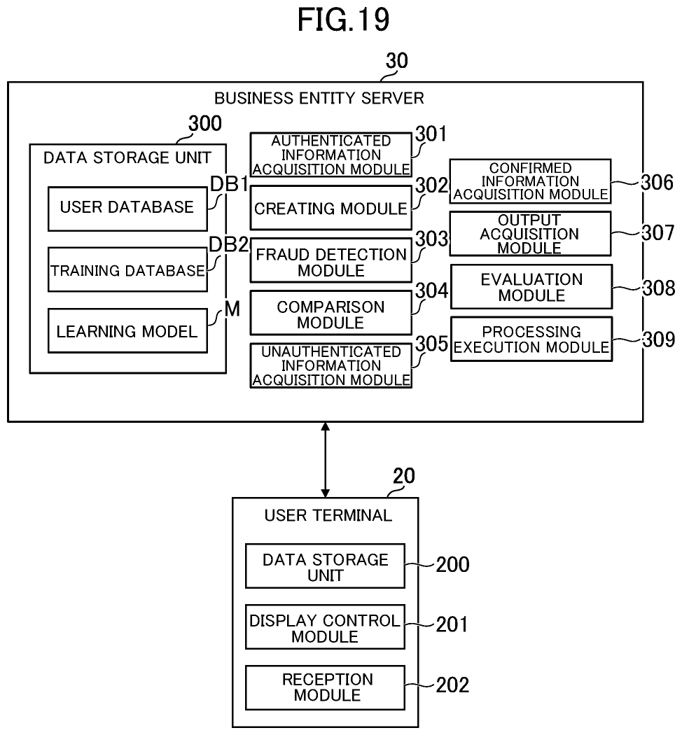

FIG. 19 is a functional block diagram in the modification examples of the second embodiment. In FIG. 19, the functions in Modification Example 2-2 to Modification Example 2-9 described after Modification Example 2-1 are also illustrated. As illustrated in FIG. 19, here, a case in which the main functions are implemented by the business entity server 30 is described. A data storage unit 300, an authenticated information acquisition module 301, a creating module 302, a fraud detection module 303, a comparison module 304, an unauthenticated information acquisition module 305, a confirmed information acquisition module 306, an output acquisition module 307, an evaluation module 308, and a processing execution module 309 are included in the business entity server 30. Each of the output acquisition module 307, the evaluation module 308, and the processing execution module 309 is implemented mainly by the control unit 31.

The data storage unit 300 is the same as in Modification Example 1-1. The authenticated information acquisition module 301, the fraud detection module 303, and the evaluation module 308 are the same as the authenticated information acquisition module 301, the fraud detection module 303, and the evaluation module 308 described in the second embodiment, respectively. The authenticated information acquisition module 301 and the fraud detection module 303 have the same function as those of the authenticated information acquisition module 301 and the fraud detection module 303 in Modification Example 1-1. The evaluation module 308 uses, for example, the correct answer rate of the learning model M for detecting fraud, for example, the use of payment means by fraudulent login by a third party as described in Modification Example 1-1, to evaluate the accuracy of the learning model M. The point that the index of the evaluation is not limited to the correct answer rate is as described in the second embodiment.

According to Modification Example 2-1, it is possible to accurately evaluate the accuracy of the fraud detection of the learning model M for detecting fraud in the electronic payment service.

### [Modification Example 2-2]

For example, the fraud detection system S may include the processing execution unit 309 which executes, when the accuracy of the learning model M becomes less than a predetermined accuracy, processing for creating the learning model M by using the latest action in the service. The processing may be processing of notifying the creator of the learning model M to create again the learning model M, or processing of creating again the learning model M by the same method as in the first embodiment. As described in the second embodiment, the notification can use any means, for example, electronic mail. The processing of creating again the learning model M may be processing of creating the learning model M like in the first embodiment by using the latest authenticated information, or a method which does not in particular create the learning model M like in the first embodiment may be used. Further, the learning model M may be created by a system other than the fraud detection system S. According to Modification Example 2-2, cases in which the accuracy of the fraud detection of the learning model M has decreased can be handled by executing processing for creating the learning model M by using the latest action in the service when the accuracy of the learning model M becomes less than the predetermined accuracy. A learning model M which has learned the latest trend can be quickly applied to the fraud detection system S, and fraud can be accurately detected. As a result, fraudulent use in the service is prevented and security is increased. Moreover, it is also possible to prevent a decrease in convenience, for example, a situation in which the action of the target user who is actually a valid user is estimated to be fraud and as a result the service is not usable by the user.

### [Modification Example 2-3]

For example, the evaluation module 308 may evaluate the accuracy of the learning model M based on the authenticated information and the confirmed information. The fraud detection system S of Modification Example 2-3 includes the same confirmed information acquisition module 306 as that in Modification Example 1-9. The evaluation method itself for the learning model M is as described in the second embodiment, but there is a difference from the second embodiment in that confirmed information is used in the evaluation of the accuracy of the learning model M. For example, the evaluation module 308 calculates the correct answer rate by using not only the authenticated information but also the confirmed information. The evaluation module 308 determines whether or not the output obtained by inputting the confirmed information to the learning model M indicates the output corresponding to the confirmed information (for example, the result of whether or not the action is a fraud designated by the creator of the learning model M), and calculates the correct answer rate. The point that any index other than the correct answer rate can be used is as described in the second embodiment.

According to Modification Example 2-3, by evaluating the accuracy of the learning model M based on the authenticated information and the confirmed information, the accuracy of the learning model M can be evaluated more accurately by using more information.

### [Modification Example 2-4]

For example, like in Modification Example 1-2, when each of the first card C2 and the second card C3 can be used, the output acquisition module 307 may acquire the output corresponding to the first card C2 based on the authenticated information corresponding to the first card C2. The evaluation module 308 evaluates the accuracy of the learning model M based on the output corresponding to the first card C2. The method itself of evaluating the accuracy of the learning model M based on the output of the learning model M is as described in the second embodiment.

According to Modification Example 2-4, the accuracy of the learning model M is evaluated based on the output corresponding to the first card C2. Through focusing on the authenticated information corresponding to the first card C2 having a very high probability of being valid, it is possible to effectively achieve the accurate evaluation of the learning model M, quick response to the latest trend, prevention of fraudulent use in the service, improvement of security, and prevention of a deterioration in convenience described in the second embodiment.

### [Modification Example 2-5]

For example, when the fraud detection system S includes the same comparison module 304 as in Modification Example 1-3, the output acquisition module 307 may acquire the output corresponding to the second card C3 based on the authenticated information corresponding to the second card C3. The evaluation module 308 evaluates the accuracy of the learning model M based on the output corresponding to the first card C2 and the output corresponding to the second card C3. The method itself of evaluating the accuracy of the learning model M based on the outputs of the learning model M is as described in the second embodiment. For example, the evaluation module 308 calculates the correct answer rate by using not only the output corresponding to the first card C2, but also the output corresponding to the second card C3. The evaluation module 308 determines whether or not the output obtained by inputting the authenticated information corresponding to the second card C3 to the learning model M indicates that the action is valid, and calculates the correct answer rate. The point that any index other than the correct answer rate can be used is as described in the second embodiment.

According to Modification Example 2-5, by evaluating the accuracy of the learning model M based on the output corresponding to the first card C2 and the output corresponding to the second card C3 when the comparison result between the first name information relating to the name of the first card C2 and the second name information relating to the name of the second card C3 is a predetermined result, the learning model M can be evaluated more accurately by using more information. As a result, it is possible to effectively achieve prevention of fraudulent use in the service, improvement of security, and prevention of a deterioration in convenience.

### [Modification Example 2-6]

For example, like in Modification Example 1-4, the second card C3 in Modification Example 2-5 may be a card that does not support possession authentication. The evaluation method itself of the evaluation module 308 is as described in Modification Example 2-5, and the only difference is that the second card C3 described in Modification Example 2-5 does not support possession authentication.

According to Modification Example 2-6, even when the second card C3 is a card that does not support possession authentication, by evaluating the accuracy of the learning model M based on the authenticated information corresponding to the second card C3, the learning model M can be evaluated more accurately by using more information.

### [Modification Example 2-7]

For example, as in Modification Example 1-1, the fraud detection system S may include the creating module 302. The creating module 302 creates, based on the authenticated information, the learning model M for detecting fraud in the service such that the action of the authenticated user is estimated to be valid. It suffices that the fraud detection system S of Modification Example 2-7 has the same configuration as in Modification Example 1-1.

According to Modification Example 2-7, it is possible to effectively achieve the simplified creation of the learning model M, quick creation of the learning model M, prevention of fraudulent use in the service, improved security, and prevention of a deterioration in convenience described in the first embodiment.

### [Modification Example 2-8]

For example, the fraud detection system S may include the same unauthenticated information acquisition module 305 as that in Modification Example 1-5. The creating module 302 may create the second training data indicating that the action of the unauthenticated user is valid or fraudulent based on the unauthenticated information, and train the learning model M based on the second training data. It suffices that the fraud detection system S of Modification Example 2-8 has the same configuration as in Modification Example 1-5. Further, the evaluation module 308 may evaluate the accuracy of the learning model M created based on the second training data. It suffices that the evaluation method is the same method as in the second embodiment or in the modification examples described above.

According to Modification Example 2-8, by creating second training data indicating that the action of the unauthenticated user is valid or fraudulent based on the unauthenticated information, and training the learning model M based on the second training data, the accuracy of the learning model M is further increased by using more information.

### [Modification Example 2-9]

For example, as in Modification Example 1-6, the creating module 302 may acquire the output from the trained learning model M based on the unauthenticated information, and create the second training data based on the output. It suffices that the fraud detection system S of Modification Example 2-9 has the same configuration as in Modification Example 1-6.

According to Modification Example 2-9, by acquiring the output from the trained learning model M based on the unauthenticated information and creating the second training data based on the output, the accuracy of the learning model M is further increased by using more information.

### [3-3. Other Modification Examples]

For example, the modification examples described above may be combined.

For example, when the fraud degree of the user can be obtained in advance, the possession authentication method may be changed in accordance with the fraud degree. The fraud degree is information indicating the degree of fraud or information indicating a level of suspicion of fraud. Here, a case in which the fraud degree is expressed by a score is described, but the fraud degree may be expressed by another index. For example, the fraud degree may be expressed by characters, for example, “S rank,” “A rank,” and “B rank.” For example, the learning model M may be used to calculate the fraud degree, or a rule may be used to calculate the fraud degree. For example, the fraud degree may be calculated such that the fraud degree becomes higher as the IP address varies more. Further, for example, the fraud degree may be calculated such that the fraud degree becomes higher as the URL accessed by the user varies more. Moreover, for example, the fraud degree may be calculated such that the fraud degree becomes higher as the access location becomes farther from the central place of use or when the access location varies more.

For example, among storage areas of the IC chip cp of the first card C2, the storage area read in NFC authentication may be different based on the fraud degree of the user. For example, in a case in which the IC chip cp includes a first storage area which requires a key for reading by the reading unit and a second storage area which does not require a key for reading by the reading unit, the input electronic money ID may be acquired from the first storage area when the fraud degree of the user is equal to or more than a threshold value. When the fraud degree of the user is less than the threshold value, the input electronic money ID may be acquired from the second storage area. In this case, information indicating from which of the first storage area and the second storage area the input electronic money ID has been acquired may be transmitted to the business entity server 30, and the information may be confirmed in the possession authentication.

Further, which of the NFC unit 23A and the photographing unit 26 is to be used for authentication may be determined in accordance with the fraud degree of the user. For example, it may be determined to use the NFC unit 23A when the fraud degree is equal to or more than a threshold value, and to use the photographing unit 26 when the fraud degree is less than the threshold value. Conversely, it may be determined to use the photographing unit 26 when the fraud degree is equal to or more than the threshold value, and to use the NFC unit 23A when the fraud degree is less than the threshold value. As another example, it may be determined to use both the NFC unit 23A and the photographing unit 26 when the fraud degree is equal to or more than the threshold value, and to use any one of the NFC unit 23A and the photographing unit 26 when the fraud degree is less than the threshold value. Information for identifying which of the NFC unit 23A and the photographing unit 26 is determined to be used for authentication may be transmitted to the business entity server 30, and the information may be confirmed in the possession authentication.

Further, when the first card C2 includes a plurality of pieces of authentication information, the authentication information to be used for authentication may be determined based on the fraud degree of the user. For example, the authentication information to be used for authentication is determined such that as the fraud degree becomes higher, more authentication information is used for authentication. Moreover, for example, the authentication information to be used for authentication is determined such that as the fraud degree becomes lower, less authentication information is used for authentication. As another example, when the fraud degree is equal to or more than a threshold value, it is determined to use first authentication information having a relatively large amount of information, and when the fraud degree is less than the threshold value, it is determined to use second authentication information having a relatively small amount of information.

For example, the fraud detection system S can be applied to any service other than the administrative service and the electronic payment service. For example, the fraud detection system S can be applied to other services such as an electronic commerce service, a travel reservation service, a communication service, a financial service, an insurance service, an auction services, or an SNS. When the fraud detection system S of the first embodiment is applied to another service, it suffices that the learning model M is created by using the authenticated information on an authenticated user who has executed predetermined authentication, for example, possession authentication, from the user terminal 20. Similarly, when the fraud detection system S of the second embodiment is applied to another service, it suffices that the accuracy of the learning model M is evaluated by using the authenticated information on an authenticated user who has executed predetermined authentication, for example, possession authentication.

For example, the card to be utilized for the possession authentication may also be an insurance card, a driver's license, a membership card, a student ID card, or another card. The card to be utilized for the possession authentication may be an electronic card (virtual card) instead of a physical card. Further, for example, when the possession authentication fails, the determination may be manually performed by an administrator. Further, for example, when the possession authentication corresponding to a certain card number fails a predetermined number of times, the card number may be restricted so that no further possession authentication is executed thereon. In this case, the card may be restricted so that the card is not registered in the app unless permission is granted by the administrator. As another example, the possession authentication may be executed by reading an information storage medium.

For example, a case in which the main functions are implemented by the server 10 or the business entity server 30 has been described, but each function may be shared by a plurality of computers.

The invention claimed is:

1. A learning model creating system, comprising at least one processor configured to:
acquire authenticated information relating to an action of an authenticated user who has executed a predetermined authentication from a user terminal from which a predetermined service is usable; and
create, based on the authenticated information, a learning model for detecting fraud in the predetermined service such that the action of the authenticated user is estimated to be valid.

2. The learning model creating system according to claim 1,
wherein the predetermined authentication is possession authentication for confirming whether a user possesses a predetermined card through use of the user terminal, and
wherein the authenticated user is a user who has executed the possession authentication from the user terminal.

3. The learning model creating system according to claim 2,
wherein each of a first card and a second card, each of which is the predetermined card, is usable in the predetermined service by the authenticated user,
wherein the at least one processor is configured to:
acquire the authenticated information corresponding to the first card, and
create the learning model based on the authenticated information corresponding to the first card.

4. The learning model creating system according to claim 3, wherein the at least one processor is configured to:
compare first name information relating to a name of the first card and second name information relating to a name of the second card,
acquire the authenticated information corresponding to the second card when a result of the comparison is a predetermined result, and
create the learning model based on the authenticated information corresponding to the first card and the authenticated information corresponding to the second card when the result of the comparison is a predetermined result.

5. The learning model creating system according to claim 3,
wherein the second card is a card other than a card which supports the possession authentication, and
wherein the authenticated information corresponding to the second card is information relating to the action of the authenticated user who has used the second card on which the possession authentication has not been executed.

6. The learning model creating system according to claim 1,
wherein the learning model is a supervised learning model, and
wherein the at least one processor is configured to create the learning model by creating first training data indicating that the action of the authenticated user is valid based on the authenticated information, and training the learning model based on the first training data.

7. The learning model creating system according to claim 6, wherein the at least one processor is configured to:
acquire unauthenticated information relating to an action of an unauthenticated user who is yet to execute the predetermined authentication, and
create second training data indicating that the action of the unauthenticated user is valid or fraudulent based on the unauthenticated information, and to train the learning model based on the second training data.

8. The learning model creating system according to claim 7,
wherein the at least one processor is configured to acquire an output from the trained learning model based on the unauthenticated information, and to create the second training data based on the output.

9. The learning model creating system according to claim 8, wherein the at least one processor is configured to change a content of the output based on the unauthenticated information obtained after the output corresponding to the unauthenticated information is acquired, and to create the second training data based on the changed content of the output.

10. The learning model creating system according to claim 9,
wherein the learning model is configured to output a score relating to fraud in the predetermined service,
wherein an upper limit value is set to the score corresponding to the unauthenticated information such that the score corresponding to the unauthenticated information indicates fraud more than the score corresponding to the authenticated information, and
wherein the learning model is configured to output the score corresponding to the unauthenticated information based on the upper limit value.

11. The learning model creating system according to claim 6, wherein at least one processor is configured to:
acquire confirmed information relating to an action of a confirmed user for which the action has been confirmed as being fraudulent or not fraudulent, and
create the learning model based on the authenticated information and the confirmed information.

12. The learning model creating system according to claim 1,
wherein the learning model is an unsupervised learning model, and
wherein the at least one processor is configured to create the learning model based on the authenticated information such that a fraudulent action in the predetermined service becomes an outlier.

13. The learning model creating system according to claim 1,
wherein the predetermined service is an electronic payment service usable from the user terminal,
wherein the predetermined authentication is authentication of the electronic payment service executed from the user terminal,
wherein the authenticated information is information relating to the action of the authenticated user in the electronic payment service, and
wherein the learning model is a model for detecting fraud in the electronic payment service.

14. A learning model creating method, comprising:
acquiring authenticated information relating to an action of an authenticated user who has executed a predetermined authentication from a user terminal from which a predetermined service is usable; and
creating, based on the authenticated information, a learning model for detecting fraud in the predetermined service such that the action of the authenticated user is estimated to be valid.

15. A non-transitory computer-readable information storage medium for storing a program for causing a computer to:
acquire authenticated information relating to an action of an authenticated user who has executed a predetermined authentication from a user terminal from which a predetermined service is usable; and
create, based on the authenticated information, a learning model for detecting fraud in the predetermined service such that the action of the authenticated user is estimated to be valid.
